(19) United States
(12) Patent Application Publication
(10) Pub. No.: US 2026/0290196 A1
(43) Pub. Date: Sep. 24, 2026

(54) SYSTEM

(71) Applicant: SoftBank Group Corp., Tokyo (JP)

(72) Inventor: Shotaro KUMOZAKI, Tokyo (JP)

(73) Assignee: SoftBank Group Corp., Tokyo (JP)

(21) Appl. No.: 19/568,898

(22) Filed: Mar. 17, 2026

(30) Foreign Application Priority Data
Mar. 19, 2025 (JP) 2025-045208

(51) Int. Cl. G09B 7/04; G06F 40/40; G06V 10/764; G06V 40/16; G09B 7/08; G10L 15/18; G10L 25/63; G10L 25/78

(52) U.S. Cl. CPC G09B 7/04; G06F 40/40; G06V 10/764; G06V 40/174; G09B 7/08; G10L 15/1807; G10L 25/63; G10L 25/78

(57) ABSTRACT

A system includes a processor that is configured to input, to a generative artificial intelligence model, a prompt for instructing generation of educational materials and to generate educational materials according to characteristics of a learner, recognize, in real time, an emotional state of the learner and adjust at least one of a difficulty level of the educational materials and a learning pace in accordance with the emotional state, and evaluate a learning progress and an understanding level of the learner and provide immediate feedback based on results of the evaluation.

### CROSS-REFERENCE TO RELATED APPLICATION

This application is based on and claims priority under 35 USC 119 from Japanese Patent Application No. 2025-045208 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional computer-aided learning systems typically provide static or semi-static educational materials that are not sufficiently adapted to individual learner characteristics. In many cases, such systems are configured only to present pre-authored content and to record basic performance metrics, for example scores and completion status, without deeply taking into account the learner's specific learning history, learning tendency, or emotional state. As a result, these systems often fail to maintain learner engagement and cannot provide an appropriate difficulty level or learning pace in real time.

Furthermore, known systems generally evaluate the learner's progress and understanding level using fixed rules or simple algorithms and therefore cannot generate rich, individualized feedback or dynamic educational materials that precisely match the learner's current needs.

In particular, immediate feedback is frequently limited to indicating correct or incorrect answers, without providing tailored explanations or guidance based on a comprehensive analysis by an advanced generative model.

In addition, existing technologies do not adequately utilize generative artificial intelligence models to simultaneously (i) generate educational materials according to detailed learner characteristics, (ii) recognize and respond to the learner's emotional state in real time, and (iii) evaluate learning progress and understanding level so as to deliver immediate, personalized feedback. Consequently, there is a need for a system that can intelligently integrate generative artificial intelligence capabilities with real-time learner analysis, including emotion recognition, to optimize educational materials, learning pace, and feedback for each individual learner.

### SUMMARY

In order to solve the above-described problems, a system according to at least one embodiment of the present invention comprises a processor, wherein the processor is configured to input, to a generative artificial intelligence model, a prompt for instructing generation of educational materials and to generate educational materials according to characteristics of a learner, to recognize, in real time, an emotional state of the learner and adjust at least one of a difficulty level of the educational materials and a learning pace in accordance with the emotional state, and to evaluate a learning progress and an understanding level of the learner and provide immediate feedback based on results of the evaluation.

In one embodiment, the processor is further configured to analyze a learning history and a learning tendency of the learner and to use a prompt based on a result of the analysis to instruct the generative artificial intelligence model to generate optimal educational materials.

By doing so, the system can cause the generative artificial intelligence model to dynamically create educational materials that are tailored to past performance, preferred learning style, and observed tendencies of the learner, thereby improving relevance and effectiveness of the content provided.

In another embodiment, the processor is further configured to use a prompt to instruct the generative artificial intelligence model to analyze the learning progress and the understanding level of the learner and, based on a result of the analysis, to provide immediate feedback to the learner. The processor can thus employ the generative artificial intelligence model not only for content generation, but also for sophisticated analytical processing, enabling generation of detailed, individualized feedback messages that explain errors, suggest remedial actions, and recommend next learning steps.

By combining these functions, the system according to embodiments of the present invention enables real-time adaptation of educational materials and learning pace based on both cognitive and emotional states of the learner, and provides immediate, AI-generated feedback that reflects ongoing analysis of learning history, learning tendency, and current performance, thereby addressing the above-mentioned technical problems.

The term “system” refers to an arrangement including at least one processor and, optionally, one or more memories, input/output devices, communication interfaces, and other hardware or software components that cooperate to perform the functions described in the present specification and claims.

The term “processor” refers to any hardware device or combination of devices that executes instructions, including but not limited to a central processing unit (CPU), a graphics processing unit (GPU), a digital signal processor (DSP), a microcontroller, an application-specific integrated circuit (ASIC), a field-programmable gate array (FPGA), or a combination thereof, and may also encompass multiple processors operating in a distributed or parallel manner.

The term “generative artificial intelligence model” refers to a machine learning model configured to generate output data, such as text, images, audio, or structured information, in response to input data, and includes, for example, a large language model, a generative adversarial network (GAN), a variational autoencoder (VAE), a transformer-based model, or any other model capable of generating educational materials or analytical results based on prompts or other input.

The term “prompt” refers to data provided to the generative artificial intelligence model, including but not limited to text, structured parameters, or encoded information, that specifies at least one of a generation request, a generation condition, an analysis request, or an analysis condition, and that causes the generative artificial intelligence model to generate educational materials or to perform analysis as instructed.

The term “educational materials” refers to information or content designed to support learning by a learner, including, for example, explanations, lectures, examples, exercises, quizzes, problem sets, hints, feedback messages, or any combination thereof, and being presented in one or more modalities such as text, images, audio, video, or interactive content.

The term “learner” refers to a human user who receives and studies the educational materials provided by the system, and whose characteristics, learning history, learning tendency, emotional state, learning progress, and understanding level may be analyzed or used by the system.

The term “characteristics of a learner” refers to information identifying or describing the learner, including but not limited to age, grade level, learning style, learning preferences, proficiency level, goals, or other personal or educational attributes that can be used to tailor educational materials to the learner.

The term “emotional state” refers to a psychological or affective condition of the learner at a particular time, including, for example, states such as interest, boredom, frustration, confusion, satisfaction, or motivation level, which can be estimated or recognized by the system based on input signals, behavioral patterns, or other data.

The term “learning pace” refers to a speed or rhythm at which educational materials are presented to the learner and at which the learner is expected or allowed to progress, including, for example, timing of content delivery, frequency of assessments, amount of material per session, or allowed response time for individual tasks.

The term “learning progress” refers to an extent or stage of advancement of the learner in one or more learning objectives or curricula, including, for example, completion status of content, improvement over time, or transition between proficiency levels.

The term “understanding level” refers to a degree to which the learner has comprehended or mastered a concept, topic, or skill, which may be represented by a qualitative category (such as beginner, intermediate, or advanced) or a quantitative score, and which may be inferred from performance data, responses to questions, or analysis results from the generative artificial intelligence model.

The term “immediate feedback” refers to information provided to the learner within a short time after the learner's activity, such as answering questions or interacting with educational materials, and may include evaluation results, explanations, guidance, or recommendations that are tailored to the learner's current state and are generated based on analysis by the processor and/or the generative artificial intelligence model.

The term “learning history” refers to accumulated data representing past learning activities of the learner, including, for example, previously studied content, scores, completion times, error types, interaction logs, and other records that can be used to infer performance trends and preferences.

The term “learning tendency” refers to patterns or preferences in the learner's behavior derived from the learning history, such as preferred content types, typical response times, common error patterns, or preferred difficulty levels, which can be used to customize future educational materials or feedback.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

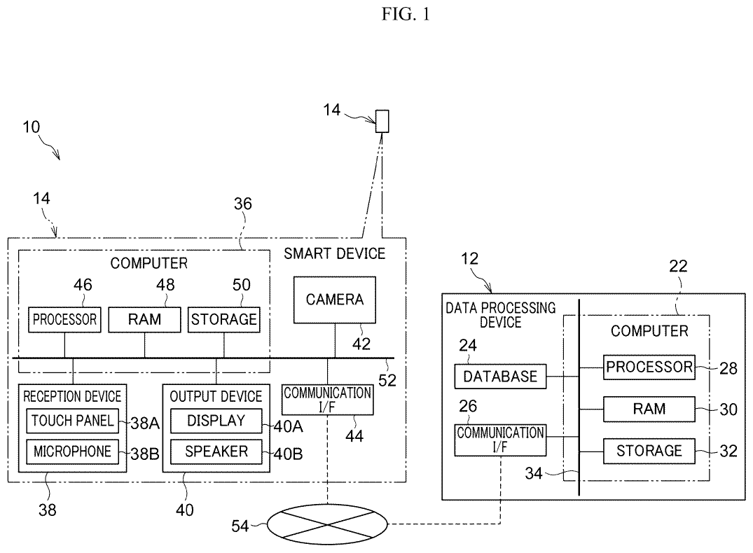

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

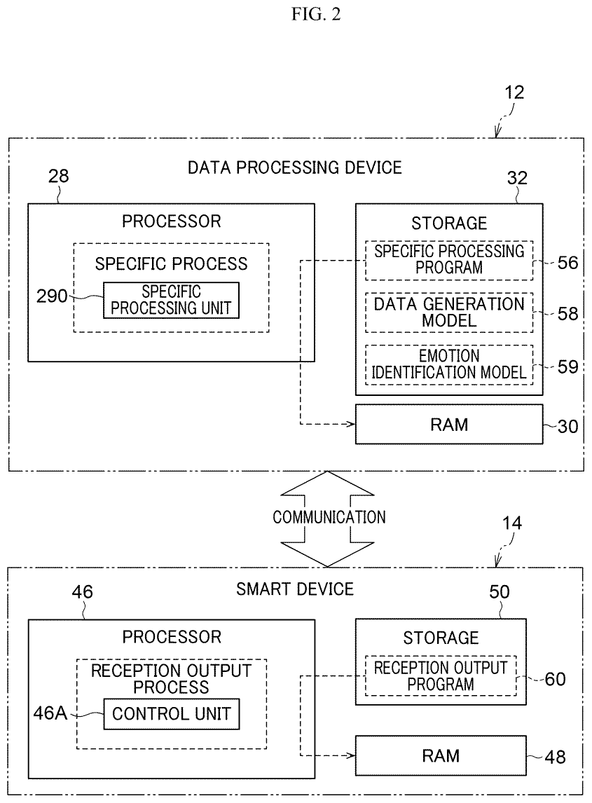

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented learning systems that deliver digital instructional content typically rely on static content selection rules, manually authored recommendation logic, or coarse-grained scoring mechanisms. In such systems, the server generally retrieves past scores or completion states from a database and applies fixed thresholds or predetermined mapping tables to select the next learning item. As a result, the computational processing on the server side is largely limited to simple database retrievals and rule-based branching, and the system lacks the capability to perform fine-grained, data-driven adaptation of educational content for each individual learner.

Further, although recent generative artificial intelligence models can produce educational text and exercises in response to input instructions, existing systems often pass only generic prompts that do not fully encode the learner's detailed learning history, learning tendencies, and current weaknesses. In these systems, the generative artificial intelligence model is not tightly integrated into the learning pipeline as a computational component that is iteratively updated based on newly acquired interaction data. Consequently, the server cannot fully exploit the available computational resources and machine learning techniques to achieve robust personalization and continuous optimization of the generated content.

Additionally, the processing loop from content generation, display on a terminal, learner response, and back to server-side analysis is typically fragmented. Many systems treat response data merely as simple log entries rather than as structured, machine-interpretable features that drive ongoing re-analysis and re-generation processes. This results in underutilization of computational analysis capabilities such as statistical aggregation and machine learning-based clustering or classification. As a result, the system is not able to dynamically refine model inputs, such as prompt sentences to the generative artificial intelligence model, in a manner that systematically improves the quality and appropriateness of the educational content over time.

Moreover, existing systems often lack a unified server-side architecture in which (i) learning history acquisition, (ii) numeric aggregation and feature extraction, (iii) machine learning-based learning tendency analysis, (iv) dynamic construction of prompt sentences to a generative artificial intelligence model, (v) post-processing of generated educational content, and (vi) automatic evaluation of learner responses are implemented as cooperating computational operations. Because of this fragmentation, the systems suffer from inefficiencies in data pipelines, increased latency, and difficulty in ensuring that the latest interaction data is reflected in subsequent content generation.

Accordingly, there is a need for an improved computer-implemented learning support system in which a server executes a series of coordinated computational steps to: (1) acquire and store detailed learning history information, (2) perform numerical aggregation and machine learning-based analysis to identify weak and strong learning domains, (3) dynamically construct and update prompt sentences to a generative artificial intelligence model, (4) generate and format individualized educational content, and (5) automatically evaluate learner responses and feed the evaluation results back into the analysis and content generation pipeline. By improving the architecture and processing flow at the server level, such a system can enhance the efficiency, responsiveness, and personalization capabilities of computer-based learning environments and thereby improve the underlying computer technology used for adaptive educational content delivery.

The specific processing by the specific processing unit 290 of the data processing device 12 in Example 1 is realized by the following means.

The present invention provides a server comprising a processor configured to: acquire learning history information of a learner from an external learning management apparatus via a communication network and store the learning history information in a storage management apparatus; read the stored learning history information into an information analysis processing apparatus, aggregate the learning history information using a numerical computation processing resource to generate feature quantities including at least an average performance for each learning unit, a learning time, and a number of attempts, and execute machine-learning-based analysis on the feature quantities using a machine-learning processing resource to identify a weak domain and a strong domain of the learner and to generate an analysis result; construct, based on the analysis result and educational target characteristics, a prompt sentence including condition information specifying at least the weak domain, the strong domain, target difficulty, explanation format, number of practice problems, and explanation style, input the prompt sentence to a generative artificial intelligence model, and cause the generative artificial intelligence model to generate individualized educational content for the learner; convert the educational content output from the generative artificial intelligence model into a display format and transmit the educational content in the display format to a terminal apparatus for presentation to the learner; acquire answer information, operation history information, and learning time information transmitted from the terminal apparatus in response to the educational content, use model answer information or evaluation criterion information included in the educational content to automatically determine the acquired answer information to generate correctness information and score information, transmit the correctness information and the score information to the terminal apparatus to provide immediate feedback, and store the correctness information and the score information as part of the learning history information in the storage management apparatus; and re-input the updated learning history information to the information analysis processing apparatus to update the analysis result and sequentially change contents of the prompt sentence for the generative artificial intelligence model in accordance with the updated analysis result so as to cause the generative artificial intelligence model to continuously generate educational content that is adaptively updated. This enables an integrated server-side computational architecture in which acquisition, analysis, generation, evaluation, and feedback are executed as coordinated computer-implemented operations, thereby improving the efficiency, adaptability, and technical performance of the computer system for delivering personalized educational content.

The term “system” refers to an arrangement including at least one server-side computing apparatus and one or more terminal apparatuses that cooperate via a communication network to perform the learning support processing described herein.

The term “processor” refers to one or more hardware processing units, such as a central processing unit or a graphics processing unit, configured to execute instructions and perform the computational operations described in the present disclosure.

The term “learning history information” refers to data representing past learning activities of a learner, including at least performance information, learning time information, content identifiers, attempt counts, and completion timestamps.

The term “learner” refers to a user of the system who engages in educational activities and for whom educational content is generated and adapted.

The term “external learning management apparatus” refers to a computing apparatus or service that manages learning-related data, such as course enrollment, content delivery, and performance records, and that is accessible to the server via a communication network.

The term “communication network” refers to a wired or wireless data transmission infrastructure, such as a local area network or a wide area network, including the Internet, that enables data exchange between the server, the external learning management apparatus, and the terminal apparatus.

The term “storage management apparatus” refers to one or more hardware and software components, such as a database system or file storage system, configured to store, manage, and retrieve learning history information and related data.

The term “information analysis processing apparatus” refers to one or more processing components, implemented by the processor executing analysis software, that perform statistical analysis, numerical computation, and machine-learning-based analysis on learning history information.

The term “numerical computation processing resource” refers to software and hardware resources used by the processor to perform arithmetic operations, aggregation, and feature computation on numerical data derived from the learning history information.

The term “feature quantities” refers to numerical or categorical values derived from raw learning history information, including at least average performance for each learning unit, learning time, and number of attempts, which are used as input to machine-learning-based analysis.

The term “machine-learning processing resource” refers to software and hardware resources used by the processor to execute machine learning algorithms, such as classification, regression, or clustering, on feature quantities to identify patterns in learner behavior.

The term “weak domain” refers to a learning domain, topic, or concept in which the learner's performance is relatively low or indicates insufficient understanding, as determined by analysis of feature quantities.

The term “strong domain” refers to a learning domain, topic, or concept in which the learner's performance is relatively high or indicates sufficient understanding, as determined by analysis of feature quantities.

The term “analysis result” refers to structured data generated by the information analysis processing apparatus that represents outcomes of statistical and machine-learning-based analysis, including at least identification of weak domains and strong domains for a learner.

The term “educational target characteristics” refers to information specifying desired properties of educational content for a learner, including at least the learner's level, learning objectives, and preferred content style or difficulty.

The term “prompt sentence” refers to a text-based instruction or set of conditions constructed by the processor and provided as input to a generative artificial intelligence model to control the generation of educational content.

The term “condition information” refers to information included in the prompt sentence that specifies constraints or requirements for generated educational content, including at least weak domains, strong domains, target difficulty, explanation format, number of practice problems, and explanation style.

The term “generative artificial intelligence model” refers to a trained computational model, such as a neural network-based language model, configured to generate text or other content in response to an input prompt sentence.

The term “individualized educational content” refers to educational material generated by the generative artificial intelligence model in accordance with the prompt sentence, which is tailored to the specific learning needs and characteristics of a particular learner.

The term “display format” refers to a data format suitable for presentation on a terminal apparatus, such as a markup format or structured text format, into which the educational content is converted by the processor.

The term “terminal apparatus” refers to a user-side computing device, such as a smartphone, tablet, or personal computer, configured to receive educational content from the server, display the content, and transmit learner interaction data back to the server.

The term “answer information” refers to data representing responses entered by the learner to questions or exercises included in the educational content.

The term “operation history information” refers to data representing interaction events of the learner with the terminal apparatus and the educational content, including at least input actions, navigation actions, and timestamps.

The term “learning time information” refers to data representing durations of time the learner spends on one or more units of educational content or tasks.

The term “model answer information” refers to reference answer data or solution data included in or associated with the educational content, used by the processor to evaluate the correctness of learner responses.

The term “evaluation criterion information” refers to rules or parameters for assessing learner responses, including at least scoring rules, correctness thresholds, and partial credit conditions.

The term “correctness information” refers to data indicating whether each learner response is correct, incorrect, or partially correct, as determined by comparison with model answer information or evaluation criterion information.

The term “score information” refers to data representing a numerical or categorical score assigned to learner responses based on evaluation criterion information.

The term “learning unit” refers to a definable segment of learning content or activity, such as a topic, lesson, or exercise set, for which performance and time can be measured and aggregated.

The term “target difficulty” refers to an intended difficulty level of generated educational content, specified as part of the condition information in the prompt sentence.

The term “explanation format” refers to a manner in which educational explanations are presented in the generated educational content, such as text-based explanations, step-by-step procedures, or conceptual summaries.

The term “explanation style” refers to stylistic attributes of the explanations in the generated educational content, such as level of technical detail, use of analogies, or degree of formality.

The term “number of practice problems” refers to a quantity parameter included in the condition information that specifies how many practice questions or exercises should be generated in the educational content.

In one embodiment, a server, a terminal, and a user cooperate to implement an adaptive learning support system that generates and delivers individualized educational content based on a learner's history and responses. The server executes a computer program stored in a non-transitory computer-readable medium. The server program is implemented, for example, on a general-purpose computing platform including at least one central processing unit (CPU), an optional graphics processing unit (GPU), a main memory, a persistent storage device, and a network interface. The server operating system may be a general-purpose operating system such as a UNIX-based system. The server uses software components including a relational database management system such as a structured query language (SQL) database (for example, a MySQL-compatible engine), a data analysis library such as a numerical computation and data table processing library (for example, Pandas in a Python runtime), a machine learning library such as a model training and inference library (for example, a Scikit-learn-compatible library), and a generative AI model implemented as a large-scale neural network (for example, a transformer-based language model running either locally or via a remote API).

The server stores learning history information in a database. The database stores tables such as a learner table, an activity table, a result table, and a generated content table. Each table is defined with specific columns. For example, the activity table includes columns such as learner identifier, learning unit identifier, topic label, score value, time spent value, attempt count, and completion timestamp. The server represents this data internally using a structured data model in which each record is a tuple of typed fields. The server accesses the database using SQL statements executed via a database connector library.

The server uses a numerical computation library to load learning history information from the database into an in-memory tabular data structure. The server represents the data as a matrix in which each row corresponds to a learner-topic combination and each column corresponds to a feature such as average score, total learning time, and attempt count. The server defines feature quantities by applying numerical operations such as grouping by learner and topic, aggregating scores with mean functions, summing learning times, and counting attempts. The server uses a numerical array structure (for example, a NumPy-like array) as the input to machine learning processing.

The server uses a machine learning library to train and apply a model that identifies weak domains and strong domains. The server can use, for example, a classification algorithm such as logistic regression, a decision-tree-based ensemble such as random forest, or an unsupervised clustering algorithm such as k-means clustering. In one embodiment, the server trains a random forest classifier that receives feature quantities (average score, total time, attempt count, and possibly additional features such as time since last attempt) and outputs a label indicating a weakness level. The server uses a loss function such as cross-entropy during training. The server updates model parameters (for example, tree splitting thresholds and node assignments in a random forest) by minimizing the loss function over historical labeled data using an optimization procedure provided by the machine learning library. In another embodiment, the server applies k-means clustering to group learner-topic pairs into clusters that correspond to latent performance profiles. The server then maps clusters with low average scores and high time to weak domains, and clusters with high scores and low time to strong domains.

The server performs these computations to improve technical performance of the system. By aggregating and transforming raw log data into compact feature quantities, the server reduces database query load and network bandwidth, since only aggregated features need to be passed into later stages. By using a trained model rather than hard-coded thresholds, the server improves classification accuracy for weak and strong domains, resulting in fewer misclassifications and less unnecessary content generation, which in turn reduces compute usage for the generative AI model. The server thus achieves improved computational efficiency and more accurate personalization as compared to conventional rule-based systems.

The server constructs a prompt sentence for a generative AI model based on the analysis result. The server maintains prompt templates as text patterns with variable placeholders. The server fills in placeholders using analysis result fields such as weak domain, strong domain, target difficulty, and preferred explanation style. For example, the server can construct the following prompt sentence when the analysis result indicates that a learner is weak in derivatives and strong in linear functions:

“Generate a learning material to help a student understand the basic concepts of calculus, focusing on derivatives.

The student is struggling with the basic rules of differentiation, especially the power rule and the product rule.

The student understands linear functions well and can handle simple algebraic manipulation. Explain the concepts in simple language, provide intuitive analogies, and include 5 practice problems with step-by-step solutions.

Avoid advanced topics such as partial derivatives or multiple integrals.”

In another situation, when the analysis result indicates that the learner has improved in derivatives but is weak in integrals, the server can construct the following prompt sentence: “Generate a set of introductory learning materials for definite and indefinite integrals for a student who recently mastered basic derivatives.

The student confuses the meaning of the integral sign and the concept of ‘area under the curve.’

Provide a step-by-step explanation, simple numerical examples, and 5 practice exercises with detailed solutions.

Avoid advanced techniques such as integration by parts or trigonometric substitution.”

The server treats each prompt sentence as a structured instruction describing conditions for content generation. The server composes the prompt sentence from multiple text segments representing domain, difficulty, explanation format, number of practice problems, and explanation style. The server may encode some of these parameters explicitly, for example by including phrases such as “use simple language,” “target high school level,” or “provide step-by-step solutions.” This structured composition is not a mere human-like drafting; instead, it is driven by computed feature quantities and model outputs, thereby embedding machine-derived patterns into the input of the generative AI model. This improves the informativeness of the model input and, consequently, the relevance and quality of the generated content.

The server invokes a generative AI model implemented as a neural network. In one embodiment, the server uses a transformer-based language model having multiple layers of self-attention, each layer including attention heads, feedforward sublayers, and normalization units. The model is pre-trained on large-scale text corpora to predict the next token given prior tokens. The server fine-tunes the model on domain-specific educational data or provides domain-specific examples via few-shot prompting. The server tokenizes the prompt sentence into subword units using a tokenizer associated with the model. The server then passes the token sequence to the model. The model performs matrix multiplications between input embeddings, weight matrices, and attention parameters to compute contextualized representations at each layer. The model uses a softmax function over the vocabulary log its to generate a probability distribution for the next token and iteratively samples or selects tokens to generate educational text.

The server controls model parameters such as maximum token length, temperature, and top-k or top-p sampling thresholds to achieve a balance between diversity and determinism in the generated content. By adjusting these parameters programmatically based on the analysis result (for example, stricter constraints for beginners to reduce complexity), the server improves the match between content and learner ability. This dynamic control of model behavior, coupled with the structured prompt sentence, constitutes a non-conventional way of operating a generative AI model, leading to technical benefits such as reduced unnecessary token generation, improved convergence of content difficulty, and reduced post-processing overhead.

The server receives the output token sequence from the generative AI model and decodes it into text. The server then parses the generated text to identify logical segments such as sections, examples, and practice problems. The server may search for pattern markers such as headings (“Introduction”, “Practice Problems”), numbered lists, or explicit delimiters. The server then converts the text into a display format such as a simplified markup language. For instance, the server can enclose section titles in heading tags and practice problems in list structures. The server stores the formatted content in the database, associating each content item with identifiers such as learner identifier, topic, and creation time. By structuring generated text into discrete units, the server can reuse portions, selectively display them, and perform fine-grained logging of learner interactions at the level of individual problems. This structured formatting improves data management and reduces redundant content generation.

The server transmits the formatted educational content to the terminal via a network interface using, for example, an HTTP-based protocol. The terminal is implemented as a user device such as a tablet, smartphone, or personal computer, having a display, an input interface (touchscreen, keyboard, or pointing device), a processor, memory, and a communication interface. The terminal executes a learning application or a web browser.

The terminal receives the educational content in the display format. The terminal parses the format using its runtime environment and renders the content on the display. The terminal displays explanation text, formulas expressed verbally, and an ordered list of practice problems. The terminal may display input fields or multiple-choice options below each practice problem. The terminal also presents interface elements allowing the user to submit answers, navigate between sections, or request hints.

The user reads the educational content presented on the terminal and interacts with the terminal. The user inputs answers to practice problems, scrolls through explanations, and may request clarifications. These interactions generate answer information, operation history information, and learning time information. The terminal measures durations, for example the time between the moment a practice problem is first displayed and the time an answer is submitted. The terminal then packages these data items as structured records and transmits them to the server.

The server receives the learner interaction data and evaluates the answers using reference information contained in the educational content. In one embodiment, the generative AI model also produces model answer information or step-by-step solutions, which are stored with the content. The server compares the user's answer information with the model answer information using deterministic string or numeric comparison or, if necessary, pattern-matching rules. For example, for a derivative problem, the server may parse expressions and compare canonicalized forms. The server generates correctness information (correct, partially correct, incorrect) and score information (numerical scores) for each answer. The server writes these correctness and score values, along with timing and attempt counts, back into the database as part of the learning history information.

The server uses the newly stored learning history information to update feature quantities.

The server loads new and existing records, aggregates them, and recomputes average scores, time spent, and attempts. The server then re-applies its machine learning model. If the model is online or periodically retrained, the server updates the model weights. In the case of a logistic regression model, the server updates weight vectors by gradient descent on a loss function such as cross-entropy. In the case of a clustering model, the server can update cluster centroids incrementally. As a result, the classification of weak and strong domains may change over time. The server then generates new prompt sentences reflecting the updated analysis result and triggers new content generation accordingly.

This feedback loop yields concrete technical advantages. Because the server automatically generates, evaluates, and logs content and responses in a structured way, the server can reduce the need for manual content tagging and manual difficulty calibration. The server thereby maintains an evolving mapping between feature quantities and prompt directive parameters, improving the accuracy and timeliness of personalization. The continuous update of prompt sentences and the generative AI model's outputs reduces the production of irrelevant or overly difficult content, lowering compute consumption and network traffic associated with unnecessary content transmission.

The server implements specific data structures and processing flows, rather than generic “data collection-analysis-display.” For example, the server uses:
A relational schema where each learner-topic pair is given a unique key to facilitate aggregation and indexing, thereby lowering SQL query costs.
A feature matrix in which rows are normalized (for example, scaling learning time and attempts) to prevent domination by outlier values, improving numerical stability and convergence of the machine learning algorithms.
An analysis pipeline in which models are evaluated using validation metrics and updated only when performance exceeds a threshold, preventing model degradation and avoiding unnecessary retraining overhead.
A prompt generation pipeline in which condition fields are encoded into both natural language phrases and structured tags to reduce ambiguity in the instructions to the generative AI model.

These data structures and flows provide a concrete improvement to computer operation, including more efficient memory usage during analysis, reduced number of database queries via pre-aggregation, and decreased size of transmitted payloads by delivering tailored content in place of generic bulk content.

The server processes data and controls the generative AI model according to non-conventional rules. The server does not merely replace a human author with a model; instead, the server transforms large volumes of log data into algorithmically computed directives that drive model behavior in a systematic and repeatable way. The prompt sentence composition, parameter adjustment, and feedback-based reconfiguration of prompts are all executed under control of computer-executed algorithms that are not customarily used in manual educational workflows. This yields a predictable and technically reproducible improvement in both the quality of generated content and the resource utilization of the computing infrastructure. Alternative embodiments can be realized. In one embodiment, the server runs the generative AI model locally on a GPU-equipped machine. The server stores model weights in a local storage device and loads them into GPU memory. The server executes inference operations by sending token sequences to GPU kernels that implement matrix multiplications and attention operations. This configuration reduces network latency and allows finer-grained control over internal parameters and intermediate representations, improving throughput for high-traffic deployments. In another embodiment, the server accesses a remote generative AI model via an application programming interface. In this case, the server focuses on optimizing request frequency and payload construction to minimize network traffic, for example by caching frequently used prompt fragments or combining multiple content generation requests into batched calls.

In another variant, the server uses different machine learning algorithms in the analysis stage, such as gradient boosting machines or neural networks that directly map feature quantities to difficulty labels. The server may incorporate additional features, such as time-of-day usage patterns, device type, and prior content formats that result in higher engagement. The server can also incorporate uncertainty estimates and confidence scores from the machine learning models to adjust the strictness of prompt directives. These alternative embodiments remain within the scope of the described system as long as the core architecture automatic derivation of prompt sentence conditions from structured learning history, dynamic generation of individualized educational content by a generative AI model, and iterative feedback-based updating of analysis remains in place.

The terminal may be implemented in various hardware configurations, including smartphones, tablets, laptops, or dedicated educational terminals. The terminal application can be a native app or a web-based front end. The terminal may cache downloaded content to reduce repeated network access, thereby lowering communication loads and improving responsiveness. The terminal can also locally track short-term timing information and transmit aggregated values to the server to reduce the granularity of logging and thus reduce bandwidth, while still providing sufficient information for server-side analysis.

The user does not need to perform any content authoring. The user simply engages with the content presented by the terminal and provides responses. The system thus provides an implementation in which the server, the terminal, and the user perform well-defined roles, and in which the server's internal data structures, numerical computations, and machine learning algorithms cooperate to realize a technically improved method of generating, managing, and delivering individualized educational content using a generative AI model and dynamically constructed prompt sentences.

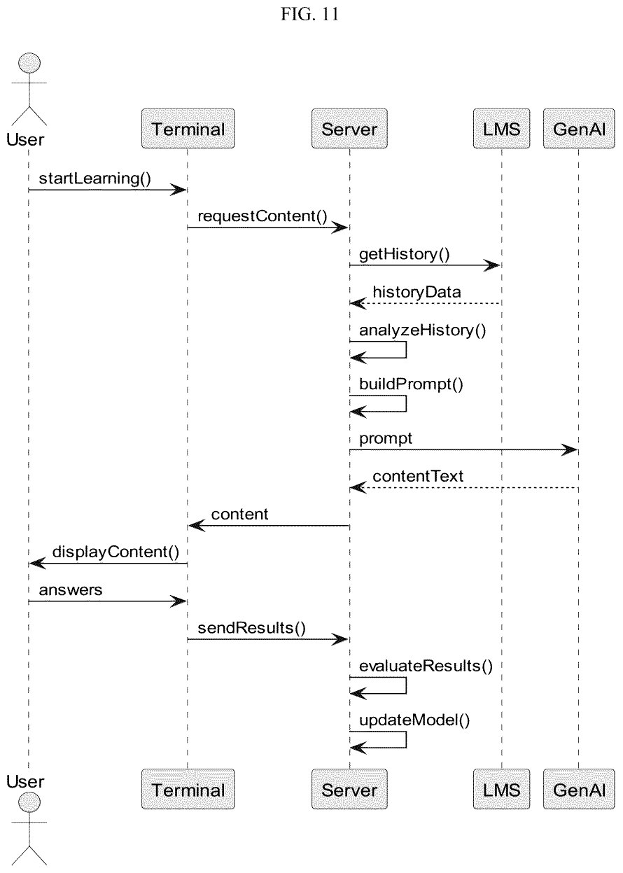

The following describes the processing flow using FIG. 11.

### Step 1:

The server acquires raw learning history information.

The server sends a request to an external learning management apparatus via a communication network and receives response data including, for each learner, identifiers of learning units, scores, time spent, attempt counts, and timestamps.

Input: response data from the external learning management apparatus (for example, in a structured text or JSON-like format).

The server parses the response data, validates required fields, converts data types (such as timestamps to a standard time format and scores to numeric types), and filters out obviously invalid records.

Output: a set of normalized learning history records, each record containing fields such as learner identifier, learning unit identifier, topic label, score value, time spent value, attempt count, and completion timestamp.

### Step 2:

The server stores the normalized learning history information.

The server connects to a relational database and executes insertion or update operations into tables such as a learner table, an activity table, and a result table.

Input: normalized learning history records generated in Step 1.

The server maps each record field to corresponding database columns, generates SQL statements for insertion or update, and commits transactions so that the data is persisted on storage.

Output: updated database state in which all recent learning history information is stored and index structures are updated to enable efficient querying.

### Step 3:

The server loads learning history information for analysis.

The server sends query statements to the database to retrieve all activity records for a specific learner or group of learners and receives result sets containing raw per-activity data.

Input: query parameters such as learner identifier and time range, and the database contents.

The server loads the query result sets into an in-memory tabular data structure, such as a data frame, and assigns explicit column names and data types to each column.

Output: an in-memory data table containing rows of learning history for the target learner, ready for numerical processing.

### Step 4:

The server computes feature quantities from raw history data.

The server groups the in-memory data table by learner and topic or learning unit and applies aggregation functions such as mean, sum, and count to derive metrics.

Input: the in-memory data table from Step 3.

The server calculates, for each learner-topic pair, at least average score, total learning time, and total number of attempts, and may derive additional features such as last-attempt time or variance of scores.

Output: a feature matrix in which each row corresponds to a learner-topic pair and each column corresponds to a feature quantity (for example, average score, total time, attempts).

### Step 5:

The server analyzes learning tendencies using a machine learning algorithm.

The server inputs the feature matrix into a trained model, such as a classifier or clustering algorithm, to determine weakness and strength levels.

Input: the feature matrix from Step 4 and stored model parameters (such as weight vectors, tree structures, or cluster centroids).

The server executes numerical operations, including matrix multiplications, threshold comparisons, and distance calculations, to assign each learner-topic pair to a label such as “weak domain” or “strong domain,” or to a cluster with a corresponding interpretation.

Output: an analysis result structure containing, for each learner, a list of weak domains, a list of strong domains, and optionally confidence scores or priority levels.

### Step 6:

The server determines educational target characteristics.

The server combines the analysis result with additional contextual information such as the learner's grade level, subject area, prior content formats that led to high engagement, and system configuration rules.

Input: the analysis result from Step 5 and stored learner profile data and configuration data.

The server applies rule-based logic or additional lightweight models to select target difficulty, preferred explanation format, number of practice problems, and explanation style for the next educational content.

Output: an educational target specification object including at least weak domains, strong domains, target difficulty level, explanation format, number of practice problems, and explanation style.

### Step 7:

The server constructs a prompt sentence for a generative AI model.

The server retrieves a prompt template corresponding to the subject and educational stage, then fills template placeholders using the educational target specification.

Input: the educational target specification from Step 6 and a stored prompt template.

The server concatenates fixed phrases and dynamically generated phrases, and embeds conditions such as “focus on [weak domain]” or “avoid [advanced topics]” into the text, thereby producing a structured prompt sentence.

Output: a completed prompt sentence text that encodes the learner's needs and desired content characteristics.

### Step 8:

The server invokes a generative AI model to generate educational content.

The server tokenizes the prompt sentence and sends the tokenized input, together with generation parameters such as maximum length and sampling settings, to a generative AI model implemented as a neural network.

Input: the prompt sentence from Step 7 and generation control parameters.

The server causes the generative AI model to perform internal numerical operations, including embedding lookup, self-attention computations, and feedforward transformations, to predict sequences of output tokens. The server decodes the output tokens into text representing explanations, examples, and practice problems tailored to the prompt.

Output: raw generated educational content text for the target learner.

### Step 9:

The server structures and formats the generated educational content.

The server scans the generated text to detect logical sections, such as introduction, explanation, examples, and practice problems, based on headings, numbering, or pattern cues.

Input: the raw generated educational content text from Step 8.

The server segments the text into section units, assigns identifiers to each section and each problem, and converts the segmented text into a display-oriented format, such as a markup-style structure with headers and lists. The server stores the formatted content with references to the learner and topic in the database.

Output: a structured educational content object that includes formatted text and metadata identifying sections and problems.

### Step 10:

The server delivers the formatted educational content to the terminal.

The server prepares a response payload containing the structured content and associated metadata, and transmits the payload through a network interface using a communication protocol.

Input: the structured educational content object from Step 9 and addressing information for the terminal.

The server writes the payload to a network socket or application programming interface endpoint and logs the transmission event for audit and debugging purposes.

Output: a network message received by the terminal containing the educational content for presentation.

### Step 11:

The terminal receives and renders the educational content.

The terminal obtains the payload from the network interface, decodes it, and parses the display format into an internal document structure.

Input: the network payload transmitted by the server in Step 10.

The terminal maps content sections to visual components, renders headings, explanatory paragraphs, and problem statements on the display, and creates interactive elements such as text input fields or selection controls associated with each problem identifier.

Output: a displayed learning screen on the terminal, visible to the user and ready for interaction.

### Step 12:

The user interacts with the educational content.

The user reads the explanations and examples, and provides answers to the practice problems via the input elements displayed on the terminal.

Input: the educational content as displayed by the terminal in Step 11.

The user operates the terminal by tapping, typing, or clicking to enter answers, navigate between sections, and submit responses.

Output: user input events and answer data captured by the terminal, including text answers, selected options, and interaction timestamps.

### Step 13:

The terminal collects and sends learner interaction data.

The terminal aggregates input events into structured records that associate each answer with a learner identifier, content identifier, problem identifier, and timing information.

Input: the user input events and answer data from Step 12.

The terminal computes durations, such as time spent per problem or per content section, and bundles answers, operation history, and learning time into a request payload, which it then transmits to the server via the network interface.

Output: a network message containing answer information, operation history information, and learning time information for the learner.

### Step 14:

The server evaluates learner answers and updates learning history.

The server receives the interaction payload, parses the answer information, and retrieves corresponding model answer information or evaluation criteria associated with the educational content from the database.

Input: the interaction payload from Step 13 and stored model answer information and evaluation criteria.

The server compares each learner answer with the model answer using deterministic checks or predefined matching rules, determines correctness, assigns scores based on the evaluation criteria, and generates correctness information and score information. The server then inserts or updates records in the database to append these evaluation results and timing data to the learner's learning history.

Output: updated learning history records including correctness information, score information, and enriched timing and attempt data.

### Step 15:

The server re-analyzes updated learning history and adjusts future prompt sentences.

The server reloads the updated learning history, recomputes feature quantities, and re-applies the machine learning model used in Step 5 to detect changes in weak and strong domains.

Input: updated learning history records from Step 14 and the stored machine learning model.

The server generates a new analysis result reflecting the learner's current performance, constructs updated educational target characteristics, and then prepares new or modified prompt sentences for subsequent content generation by the generative AI model.

Output: an updated analysis result and one or more adjusted prompt sentences that will guide future educational content generation for the learner.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented learning support systems typically deliver static or pre-authored educational content whose structure, difficulty, and pacing are defined in advance. Even when such systems track basic performance indicators, such as scores or completion status, the underlying software architecture generally applies fixed rule-based branching. As a result, the processing performed by the computer is limited to simple retrieval and display of pre-existing materials, and the system is not able to dynamically adapt its internal data processing and content generation mechanisms to the evolving state of each learner.

Furthermore, in many existing systems, a learner model is updated in a coarse-grained manner, for example by incrementing counters or storing aggregate scores, without exploiting that data to drive fine-grained content generation. The processor mainly acts as a conduit between a content repository and a user interface, so that the computational resources of the machine are underutilized. In particular, there is no systematic mechanism for the processor to (i) compute weak areas per learner through structured aggregation and statistical analysis, (ii) translate those computed weak areas and learner attributes into machine-optimized prompt sentences for a generative AI model, and (iii) continuously refine both prompts and generated materials in a closed feedback loop based on new interaction data and emotional state information.

Additionally, many systems treat a generative AI model, if used at all, merely as a black-box content generator invoked with ad hoc, manually defined text inputs. This limits the reproducibility, controllability, and efficiency of the computer's operation. Without programmatically structured prompt generation driven by analyzed learning history and real-time interaction data, the system cannot reliably control the educational function of the generative model, and the processor cannot systematically optimize its own content generation workflow.

Moreover, conventional systems rarely incorporate real-time emotional state information into the computational pipeline. Even when some emotional indicators are collected, those indicators are often used only for display or logging purposes, and are not fed back into the algorithms that determine difficulty levels, pacing, or the generation parameters of new educational materials. As a result, the computer does not perform any technically meaningful adjustment of its processing parameters in response to emotional state, and thus does not improve the way in which the machine allocates its resources or configures its generative operations.

In summary, there is a need for an improved computer-implemented learning support system in which the processor performs specific, technical data processing operations: (1) automatically acquiring and structurally analyzing learning history data to identify weak areas per learner; (2) dynamically constructing prompt sentences as machine-oriented control signals for a generative AI model, based on weak areas, learner attributes, interaction data, and emotional state; (3) iteratively updating learning history and re-running the analysis and prompt construction in a closed loop; and (4) using the generative AI model not merely as a content source, but as a computational component whose behavior is precisely controlled through programmatically generated prompts. Such a system can improve the functioning of the computer itself by enabling more efficient, adaptive control of generative processing, optimized data flows between storage, processor, and model, and automated, fine-grained adjustment of difficulty and pacing parameters in response to computed learner state.

The specific processing by the specific processing unit 290 of the data processing device 12 in Application Example 1 is realized by the following means.

The present invention provides a server comprising a processor and a storage device, the processor being configured to execute instructions to acquire, based on identification information of a learner included in input information, learning history information from the storage device, perform aggregation processing and statistical processing on performance information and behavioral information included in the learning history information for each learning item to identify a weak area of the learner, dynamically construct a prompt sentence for instructing a generative AI model to generate educational information based on the weak area and attribute information regarding the learner, input generation instruction information including the prompt sentence into the generative AI model, obtain personalized educational information output from the generative AI model in response to the prompt sentence, convert the educational information into a display data format and distribute the converted educational information to an information terminal, update the learning history information based on response information and operation information of the learner with respect to the educational information acquired from the information terminal and repeatedly execute, on the updated learning history information, a process of identifying the weak area and dynamically constructing the prompt sentence so as to incrementally optimize the educational information, acquire an emotional state of the learner over time and adjust a difficulty level and an amount of presentation of the educational information generated by the generative AI model by changing a difficulty condition and a learning pace condition in the prompt sentence according to the emotional state, and evaluate a learning progress and a level of understanding of the learner based on an analysis result using the generative AI model and the learning history information, generate immediate feedback information according to an evaluation result, and transmit the immediate feedback information to the information terminal. This enables the computer system to technically improve its operation by automatically transforming raw learning history data, interaction data, and emotional state information into structured, machine-readable control parameters for the generative AI model, thereby optimizing the generation workflow of educational information, reducing reliance on static content repositories and manual prompt design, and realizing a closed-loop, adaptive processing architecture in which the processor repeatedly reconfigures difficulty, pacing, and content parameters in response to computed learner state, resulting in more efficient utilization of computational resources and enhanced responsiveness of the system.

The term “system” refers to an arrangement including at least one processor and at least one storage device, optionally in combination with one or more information terminals and communication interfaces, that cooperatively execute programmed instructions to perform the claimed processing.

The term “processor” refers to a hardware information processing unit, such as a central processing unit or a processing core, configured to execute computer-readable instructions to perform arithmetic operations, logical operations, data transfer operations, and control operations.

The term “storage device” refers to a hardware memory component, such as a semiconductor memory or a magnetic or optical storage medium, configured to store programs, parameters, learning history information, prompt sentences, and educational information.

The term “information terminal” refers to an electronic apparatus, such as a portable terminal, a desktop terminal, or a display-equipped communication device, configured to communicate with the server, present educational information to a learner, and acquire input operations and responses from the learner.

The term “learner” refers to a human user who receives educational information from the system and performs learning activities, such as viewing content, answering questions, and providing responses through an information terminal.

The term “input information” refers to data received by the processor from an external source, including at least identification information associated with a learner and optionally including requests for learning content, operation commands, or interaction data.

The term “identification information” refers to information that uniquely or quasi-uniquely distinguishes a learner within the system, such as a user identifier, an account identifier, or a login token.

The term “learning history information” refers to structured data stored in the storage device that records a learner's past learning activities, including information such as learning items, performance information, behavioral information, timestamps, and cumulative metrics.

The term “learning item” refers to a unit or category of learning content, such as a topic, a subtopic, a concept, a lesson, or a problem type, to which performance and behavioral information are associated.

The term “performance information” refers to data representing outcomes of learning activities for a learning item, such as scores, correctness indicators, completion status, grades, or other quantitative or qualitative evaluation results.

The term “behavioral information” refers to data representing the learner's interaction behavior with respect to a learning item, including, for example, time spent, number of attempts, navigation patterns, input operations, and response sequences.

The term “aggregation processing” refers to a data processing operation in which multiple items of performance information and behavioral information are combined to produce summarized metrics, such as averages, totals, counts, or distributions.

The term “statistical processing” refers to a data analysis operation that applies statistical techniques to learning history information, such as computing variances, standard deviations, trends, correlations, or other statistical indicators.

The term “weak area” refers to at least one learning item or group of learning items for which the learning history information indicates that the learner's performance or stability of understanding is below a predetermined criterion, as determined by aggregation processing and statistical processing.

The term “attribute information regarding the learner” refers to data describing characteristics of a learner, such as age range, grade level, proficiency level, preferred language, learning goals, or preferred content style.

The term “generative AI model” refers to an artificial intelligence model, such as a generative model based on machine learning, configured to generate new information, including natural language text, in response to input data including a prompt sentence.

The term “prompt sentence” refers to text data, optionally including multiple sentences or segments, that is constructed by the processor as an instruction or query to the generative AI model to control the type, content, difficulty level, or structure of educational information to be generated.

The term “generation instruction information” refers to information transmitted from the processor to the generative AI model, including at least a prompt sentence and optionally including model parameters, control settings, or context data that specify how educational information is to be generated.

The term “educational information” refers to data generated by the generative AI model or stored in the system for the purpose of supporting learning, including explanations, examples, questions, quizzes, feedback messages, and other instructional materials.

The term “personalized educational information” refers to educational information that has been generated or selected based on learning history information, weak areas, attribute information regarding the learner, or emotional state, such that the information is tailored to a specific learner.

The term “display data format” refers to a data structure suitable for presentation on an information terminal, such as markup data, structured text, or graphical layout data, that enables the educational information to be rendered in a user interface.

The term “response information” refers to data representing explicit answers or input provided by the learner in relation to the educational information, such as selected options, entered text, submitted solutions, or confirmations.

The term “operation information” refers to data representing operations performed by the learner on the information terminal, such as button presses, scrolling actions, navigation events, or interaction events that occur while the learner engages with the educational information.

The term “incrementally optimize” refers to repeatedly updating educational information and associated control parameters based on newly obtained learning history information, response information, and operation information, such that the content, difficulty, and structure of educational information are progressively adjusted over time.

The term “emotional state” refers to an inferred or detected affective condition of the learner, such as engagement, frustration, confusion, or confidence, which is obtained over time by the system using one or more sensors, interaction patterns, or analytical models.

The term “difficulty condition” refers to a parameter or set of parameters included in or derived from a prompt sentence that specify a difficulty level of educational information to be generated, such as complexity of questions, abstractness of explanations, or required prerequisite knowledge.

The term “learning pace condition” refers to a parameter or set of parameters included in or derived from a prompt sentence that specify a temporal or volumetric pacing of educational information, such as amount of content per session, frequency of quizzes, or progression speed across learning items.

The term “learning progress” refers to an evaluation of how far the learner has advanced in a learning sequence or curriculum, as determined based on learning history information, including completed items, scores, and time-based measures.

The term “level of understanding” refers to an evaluation of the learner's comprehension or mastery of one or more learning items, which is inferred from performance information, behavioral information, and, in some cases, analysis results from the generative AI model.

The term “analysis result using the generative AI model” refers to data obtained by causing the generative AI model to process learner-related information, such as answers or explanations, in response to a prompt sentence, and to output structured or unstructured information indicating error tendencies, misconceptions, or inferred understanding.

The term “immediate feedback information” refers to information generated by the processor and transmitted to the information terminal in temporal proximity to a learner's action, such as a response to a question or completion of a task, and that communicates evaluation results, hints, corrections, or guidance.

The term “character string generation process” refers to a process executed by the processor to construct a prompt sentence by inserting parameters, such as weak areas, learner attributes, difficulty conditions, and learning pace conditions, into a prepared template or by programmatically concatenating and formatting text fragments.

The term “template of the prompt sentence” refers to a predefined text pattern including placeholders or variables, which is used by the processor as a basis for generating a concrete prompt sentence by substituting specific parameters corresponding to a learner's state.

The term “answer information” refers to data representing how the learner answered questions included in the educational information, such as chosen options, entered results, correctness indicators, and associated metadata.

The term “answer time information” refers to data indicating temporal aspects of answering behavior, such as the time required for a learner to respond to each question, the time interval between questions, or timestamps associated with responses.

The term “error tendency” refers to a pattern of mistakes or recurrent incorrect responses by the learner, such as systematic misunderstandings, frequent confusion between specific concepts, or typical wrong answer choices, as extracted from answer information.

The term “question range” refers to a scope or subset of learning items, topics, or concepts that are to be targeted by the next generated educational information, such as a specific subtopic or group of related skills.

In one embodiment, a server cooperates with a terminal and a user to implement the invention. The server includes at least one processor, a main memory, a non-volatile storage device, and a network interface. The server uses a general-purpose operating system, such as a server-class operating system, and an application platform, such as a web application framework implemented in a programming language runtime. The storage device stores learning history information, prompt sentences, model parameters, and generated educational information in structured data formats, such as relational tables or document records. The network interface connects the server to one or more terminals operated by users.

The server executes an application program that manages learning history information of each user. The server stores the learning history information in a database management system, such as a relational database engine (for example, an SQL-based engine) or a document-oriented database. The server represents the learning history information as records, each record including fields such as a user identifier, a learning item identifier, a score value, a number of attempts, timestamps for attempts, and behavioral metrics such as total time spent and number of hint requests. The server maintains indexes on at least the user identifier and the learning item identifier to allow efficient retrieval and aggregation across large populations of users.

The server uses data processing libraries, such as numerical computation libraries and data frame libraries, to process the learning history information in main memory. The server loads into memory one or more sets of records corresponding to a target user and computes aggregated metrics per learning item. The server calculates arithmetic means, weighted means, variances, and moving averages of score values. The server also computes distributions of answer times and frequencies of incorrect answers per learning item. The server evaluates whether each learning item satisfies predefined weak-area conditions, such as the average score being lower than a threshold or the variance of scores exceeding a threshold value, and the number of attempts exceeding a minimum count. The server registers, in memory, identifiers of learning items that satisfy weak-area conditions as weak areas.

The server maintains attribute information regarding each user, such as an estimated proficiency level, a grade band, a preferred interface language, and preferred content density.

The server stores the attribute information in association with the user identifier in the storage device. The server retrieves the attribute information when constructing control signals for a generative AI model. In this embodiment, the generative AI model is implemented as a large-scale neural network model, such as a transformer-based language model. The server accesses the generative AI model via a model-serving interface, which may be provided as a network-accessible inference endpoint or as a locally hosted model server.

The server constructs a prompt sentence as a control structure for the generative AI model.

The server utilizes a template of a prompt sentence stored in the storage device. The template includes placeholders for learner attributes, weak areas, difficulty conditions, and learning pace conditions. The server performs a character string generation process in which the server replaces placeholders in the template with concrete values derived from the learning history information, the weak area list, and the attribute information. The server may use multiple hierarchical templates to separate system-level instructions from user-level educational objectives.

For example, the server can generate a prompt sentence such as:

“The user is a high school learner who struggles with the basic concepts of differential and integral calculus. Please generate a step-by-step explanation of derivatives and integrals, three simple worked examples for each concept, and a short practice quiz with 5 questions and detailed answers. Use clear and concise language suitable for a beginner.”

In another example, the server can generate a prompt sentence such as:

“The user has studied basic derivative rules and correctly answered most simple derivative problems but still makes mistakes on chain rule problems. Please generate 10 practice problems focusing only on the chain rule, in increasing order of difficulty. For each problem, provide a detailed step-by-step solution and a short intuitive explanation, using terminology suitable for a high school learner.”

The server may further generate a prompt sentence that incorporates emotional state information, such as:

“The user's recent interaction data indicate signs of frustration and longer answer times. Please generate shorter and easier practice questions on English irregular past tense verbs, with very clear examples and immediate feedback messages after each question to support the user's confidence.”

The server transmits the prompt sentence, together with configuration parameters such as maximum output length and randomness control parameters, to the generative AI model.

Internally, the generative AI model is composed of multiple layers of attention blocks, feed-forward networks, and normalization components. The model has been trained beforehand on large-scale text data using a training procedure that minimizes a prediction error function, such as cross-entropy loss between predicted token distributions and ground-truth token sequences. During training, the model updates its weight parameters using gradient-based optimization, such as stochastic gradient descent or a variant optimizer. The training process also can involve data augmentation strategies, such as masking words, shuffling sentence order, or introducing paraphrased variants, to enhance robustness and generalization.

During inference, the server provides the prompt sentence to the generative AI model, which then executes matrix multiplications, non-linear activations, and attention computations to generate one or more token sequences representing educational information. The server receives the generated token sequences and consolidates them into a text document. The server parses the document by detecting semantic markers, such as headings, numbered lists, or key phrases (for example, “Example,” “Question,” and “Answer”) to split the text into structured segments. The server may apply rule-based post-processing, such as enforcing that a quiz section contains a specified number of questions or correcting inconsistencies in numbering.

The server converts the structured educational information into a display data format suitable for the terminal. The server may transform segments into markup with headings, paragraphs, and interactive elements. For quizzes, the server may define a data structure listing question identifiers, question texts, answer choices, correct answers, and hints. The server stores the converted educational information in the storage device and assigns identifiers to enable later retrieval and logging.

The terminal is implemented as a computing device having a processor, memory, a display device, input interfaces, and a communication module. The terminal executes a client application, such as a web browser or a native learning application, which communicates with the server via a network. The terminal receives the display data format from the server and renders the educational information on the display device. The terminal organizes the content into sections, such as “Explanation,” “Examples,” and “Quiz,” and supports user operations such as scrolling, selecting answers, entering text, and requesting hints.

The user observes the explanation and examples on the terminal and interacts with the quiz elements. The user selects answer options, types responses, or confirms completion of sections. The user may interact with the terminal at varying speeds and with different patterns of navigation. The terminal records, for each interaction, timestamps, identifiers of the relevant educational segments, and the raw input values entered by the user. The terminal forwards this response information and operation information to the server.

The server receives the response information and operation information from the terminal.

The server stores this data in the learning history information for the user, together with updated timestamps, computed scores, and derived behavioral metrics. The server may estimate answer correctness by matching a user's responses against expected answers defined in the quiz data structure. The server calculates new performance information, such as quiz percentage scores, and new behavioral information, such as time spent per question and number of retries.

In some embodiments, the server also receives, from the terminal or from auxiliary sensors, signals related to the emotional state of the user. The server may infer emotional state using classification models applied to interaction patterns, such as extremely short or long response times, frequent switching between questions, or repeated use of hints. The server can implement a classifier model as a smaller neural network trained on labeled samples of behavioral sequences and emotional labels. The server assigns emotional state labels, such as “engaged,” “confused,” or “frustrated,” and records these labels over time.

The server uses the updated learning history information and emotional state labels to refine the identification of weak areas and to adjust difficulty conditions and learning pace conditions. The server may, for example, define a non-linear mapping function that reduces difficulty levels more aggressively when persistent low scores and frustration signals are detected. The server encapsulates these adjustments into new parameters that will be embedded into future prompt sentences. By doing so, the server uses the machine's ability to integrate high-dimensional behavioral and performance data, which would not be feasible for manual human tuning at similar temporal and spatial scales.

The server uses the generative AI model not only to generate new educational content but also to analyze user responses at a semantic level. In one embodiment, the server constructs a prompt sentence that includes user answers and requests an analysis of typical misconceptions. For example, the server may generate a prompt sentence such as:

“The user answered the following calculus problems with the given responses. For each incorrect response, identify the most likely misunderstanding and summarize the error pattern in one sentence per question.”

The server passes this analysis request to the generative AI model, which generates a structured text list of misconceived reasoning patterns. The server parses this output and encodes it as error tendency features, such as recurring confusion between derivative rules, misapplication of sign changes, or misinterpretation of irregular verb forms. The server then uses these features as inputs to rule-based or model-based logic that determines adjustments in forthcoming prompt sentences, such as emphasizing specific sub-rules, adding concrete counterexamples, or including more step-wise explanation.

Through these operations, the server improves computer technology itself in several ways.

The server reduces the communication load by pre-aggregating and compressing user interaction data before transmitting only summarized metrics to the generative AI model when analysis is required, instead of sending all raw logs. The server optimizes data management by structuring learning history information into normalized tables and indexed views, enabling more efficient queries and reducing input/output operations. The server increases calculation efficiency by using batch computation for multiple learners, vectorized operations in data processing libraries, and shared caching of intermediate computation results, such as precomputed topic difficulty baselines.

Furthermore, the server improves the technical operation of the generative AI pipeline by programmatically generating prompt sentences based on quantitative metrics and structured templates. Unlike manual prompt crafting, which is static and inconsistent, the server uses deterministic rules and machine-computed features to produce prompts that systematically control the behavior of the generative AI model. This leads to more predictable output distributions, faster convergence to suitable difficulty levels, and reduced need for repeated trial-and-error calls to the model. In other words, the server configures the model's generative process in a non-conventional manner that leverages internal data structures and algorithms of the computing system, rather than merely automating human text generation.

The server, by iteratively updating learning history and running the analysis loop, reduces error rates in content targeting and increases the precision of weak area detection. The server's repeated recalibration of difficulty and pacing conditions, based on objective and derived metrics, causes the generative AI model to produce content sequences that more closely match the learner's current state. The result is a decreased number of overly simple or overly complex materials delivered, which in turn reduces wasted computation and network bandwidth. The causal relation is that the structured data pipeline and dynamic prompt construction alter the selection of tokens generated by the model, thereby changing the actual computational path taken within the model's network layers, leading to more efficient token generation per unit of learning gain.

In alternative embodiments, the server can host the generative AI model locally, using a dedicated graphics processing unit or specialized accelerator hardware. In this case, the server deploys an inference engine that reads the trained model weights from the storage device into device memory and runs forward-pass computations on demand. The server can schedule inference tasks for multiple users by queueing prompt sentences and allocating GPU time slices, leveraging parallelization to improve throughput. The model architecture may vary, such as including encoder-decoder structures, additional attention heads for educational meta-tags, or specialized output heads trained on educational corpora.

In another embodiment, the server can implement different strategies for constructing prompt sentences, such as using hierarchical meta-prompts that first set high-level pedagogical goals and then specify lower-level details, or using context-chaining techniques in which a series of short prompt sentences conditions the generative AI model step by step. The server may also adopt alternative machine learning algorithms to classify weak areas, such as gradient boosting models, clustering algorithms, or reinforcement learning policies that select content difficulty based on expected learning gain.

The terminal may also vary in form, such as being integrated into classroom equipment, head-mounted displays, or other interactive devices. The server can adapt the display data format to the terminal type, for instance simplifying layouts for low-resolution devices or including additional interactive visualizations for high-performance terminals.

Through these embodiments, the server, the terminal, and the user cooperate in a technical framework that is not limited to abstract data manipulation. The server performs specific data transformations and applies structured control over a generative AI model using computed metrics and algorithmic rules. These operations improve the speed, precision, and efficiency of the computer system's content generation and delivery functions, thereby providing a concrete enhancement to computer technology, beyond mere automation of human educational content creation.

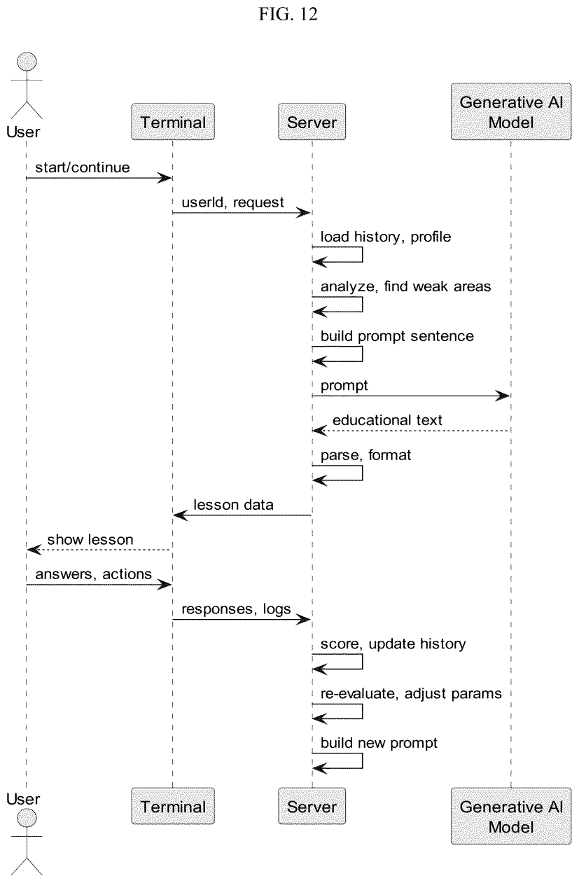

The following describes the processing flow using FIG. 12.

### Step 1:

The user operates the terminal to start or resume a learning session.

The terminal receives, as input, a user identifier and a request type (for example, “start new lesson” or “continue calculus”). The terminal packages these as request data and transmits the request data to the server via a network. The terminal outputs a network message including the user identifier and the request type.

### Step 2:

The server receives, as input, the request data from the terminal including the user identifier and the request type. The server uses the user identifier to query a storage device, such as a relational database, and retrieves learning history records and attribute records associated with the user. The server performs lookup and filtering operations on indexed tables to obtain only records relevant to the current learning domain (for example, mathematics or language).

The server outputs a set of learning history data and a set of user attribute data in a structured in-memory format.

### Step 3:

The server receives, as input, the learning history data for the user. The server loads this data into a data processing module (for example, using a data frame library) and executes numerical operations to compute aggregated performance metrics per learning item, such as average score, number of attempts, total time spent, and score variance. The server compares these metrics against predetermined thresholds and rules to determine which learning items qualify as weak areas. The server outputs a weak-area list that includes identifiers and names of learning items classified as weak for the user.

### Step 4:

The server receives, as input, the weak-area list and the user attribute data. The server selects one or more target learning items from the weak-area list according to a selection rule, such as selecting the item with the lowest average score or the item with persistent low performance over several sessions. The server also determines a target difficulty level and a desired learning goal (for example, “initial understanding” or “focused practice”). The server combines the target learning items, difficulty level, and learning goal into a learning context data structure. The server outputs this learning context as input to a prompt construction module.

### Step 5:

The server receives, as input, the learning context. The server selects a prompt template string stored in the storage device that is appropriate for the learning domain and learning goal. The server substitutes placeholders in the template with concrete values from the learning context, such as the learning item name, user proficiency level, difficulty level, and desired content structure (for example, explanation, examples, and quiz). The server thereby performs string concatenation and token insertion operations to generate a complete prompt sentence in natural language. The server outputs the constructed prompt sentence as a text structure.

### Step 6:

The server receives, as input, the constructed prompt sentence. The server optionally reads additional configuration parameters, such as maximum output length and randomness control values, from the storage device or configuration files. The server assembles an inference request that includes the prompt sentence and the configuration parameters. The server transmits this inference request to the generative AI model through a model-serving interface, which may be an internal process or an external network endpoint. The server outputs the inference request to the generative AI model.

### Step 7:

The generative AI model receives, as input, the inference request including the prompt sentence and configuration parameters. The generative AI model tokenizes the prompt sentence into a sequence of token identifiers, processes the sequence through multiple neural network layers (for example, transformer blocks that perform matrix multiplications and attention computations), and generates output tokens that represent personalized educational information. The generative AI model decodes the output tokens into natural language text.

The generative AI model outputs generated educational text to the server.

### Step 8:

The server receives, as input, the generated educational text from the generative AI model.

The server parses the educational text to detect logical sections such as explanations, worked examples, and quiz questions by searching for key phrases, numbering patterns, and line breaks. The server then structures the parsed content into an internal representation that includes section types, section contents, and metadata such as topic identifiers and difficulty indicators. The server converts this internal representation into a display data format (for example, structured text with markers for UI rendering). The server outputs the display data format for transmission to the terminal.

### Step 9:

The server receives, as input, the structured display data format. The server associates the content with a content identifier and stores a copy of the structured data in the storage device for logging and future reference. The server then encapsulates the display data format into a response message addressed to the terminal. The server transmits this response message over the network. The server outputs the response message containing the personalized educational information.

### Step 10:

The terminal receives, as input, the response message containing the display data format. The terminal parses the display data, maps each section (explanation, examples, quiz) to corresponding user interface components, and renders the content on the display device. The terminal applies layout rules, such as splitting the screen into text and answer areas, and activates interactive elements such as selectable options and text input fields. The terminal outputs a visual presentation of the educational information and interactive controls for the user.

### Step 11:

The user views, as input, the visual presentation of the educational information on the terminal. The user reads explanations, studies worked examples, and interacts with the quiz elements by selecting choices, typing answers, or pressing navigation buttons. The user's operations produce explicit answer data (choices and typed text) and implicit behavioral data (timing, scrolling, and navigation patterns). The user outputs these interactions to the terminal through the input interfaces.

### Step 12:

The terminal receives, as input, the user's interactions including answers and operation logs. The terminal timestamps the events, associates them with question identifiers and content identifiers, and compiles response information and operation information in a structured format. The terminal may compute simple local metrics, such as time spent per question, before sending the data. The terminal transmits the compiled interaction data to the server via the network. The terminal outputs a request message including the response information and operation information.

### Step 13:

The server receives, as input, the interaction data from the terminal. The server validates the data, identifying the user and content identifiers, and determines correctness of answers by comparing user responses with expected answers stored in the content data structure. The server computes updated performance metrics for each learning item, such as new scores, updated averages, number of attempts, and updated time metrics. The server writes these metrics into the learning history records in the storage device using update operations. The server outputs updated learning history information for use in subsequent analysis.

### Step 14:

The server receives, as input, the updated learning history information and, if available, emotional state indicators derived from the interaction patterns. The server runs an evaluation module that recomputes weak areas using aggregation and statistical functions over the extended learning history. The server also determines whether the learner's performance on previously weak areas has improved above specified thresholds and whether difficulty or pacing parameters should be adjusted (for example, increasing difficulty after sustained high scores, or decreasing difficulty when low scores and long answer times persist). The server outputs a revised weak-area list and updated difficulty and pacing parameters.

### Step 15:

The server receives, as input, the revised weak-area list and the updated difficulty and pacing parameters. The server incorporates these inputs into a new learning context, which reflects the latest state of the learner. The server repeats the prompt construction process using this updated context, generating a new prompt sentence that specifies refined educational objectives and adjusted difficulty and pacing conditions. The server outputs this new prompt sentence and, as a result, initiates another cycle of content generation through the generative AI model, thereby continuously adapting the educational information to the learner.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented learning systems generally rely on static content selection rules and coarse-grained performance metrics. Such systems often compute only simple scores, such as a total number of correct answers, and then select pre-authored content according to fixed thresholds. As a result, these systems have limited ability to adaptively generate fine-grained feedback or to tailor the sequencing, difficulty level, and presentation speed of educational content to individual learners in real time.

Furthermore, in many existing architectures, raw interaction data from a terminal device, such as answer selections and timestamps, is not normalized or structured in a way that can be effectively reused for iterative content generation. In particular, learning activity data is typically stored as unprocessed logs that are not systematically transformed into reusable evaluation information. This makes it difficult for a computing system to construct rich, context-sensitive input to a generative AI model, and restricts the system to simplistic prompts that do not fully exploit the model's capabilities.

In addition, conventional systems often treat generative AI components as separate “black-box” modules that are manually prompted by human operators or by fixed templates that do not reflect current performance indicators or learner history. Consequently, the generated feedback is not tightly coupled to computed learning indicators such as per-learner correctness ratio, response time, or weak areas, and the system cannot automatically adjust the educational content flow based on the generated feedback. This leads to inefficiencies both in the way the computing resources are used and in the overall responsiveness of the system.

Moreover, many known systems do not estimate learner state, such as emotional state or cognitive load, from low-level interaction signals and evaluation information, and therefore cannot adjust content difficulty and presentation speed at the system level. From a computer-technology perspective, the lack of integrated pipelines that (i) derive structured learning indicators from heterogeneous interaction data, (ii) construct dynamic prompt sentences, and (iii) close the loop by automatically reconfiguring content selection and presentation, results in suboptimal utilization of processing resources and network resources, as multiple disjoint subsystems must be coordinated manually or through static configuration.

Accordingly, there is a need for an improved computer-implemented system and method that (1) transforms raw learning activity information into structured understanding evaluation information, (2) uses that information to dynamically generate prompt sentences for a generative AI model, (3) automatically obtains and applies personalized feedback to control educational content difficulty, order, and presentation timing, and (4) stores and reuses learning history information to iteratively improve subsequent prompting and content generation. Such improvements constitute an advancement in computer technology by providing an integrated, automated control loop between data acquisition, data processing, prompt generation, AI-based content generation, and user interface control.

The specific processing by the specific processing unit 290 of the data processing device 12 in Example 2 is realized by the following means.

The present invention provides a server comprising a processor configured to acquire, from a terminal device, interaction data including operation information and answer information of a learner, to associate the interaction data with time-series information as learning activity information, to compute, based on the learning activity information, learning indicators including a number of questions, a number of correct answers, a correctness ratio, a learning time, and a response time for the learner, and to generate understanding evaluation information; the processor further configured to automatically construct a prompt sentence for a generative AI model on the basis of the understanding evaluation information and history information of the learner, to input the constructed prompt sentence to the generative AI model, and to obtain, from the generative AI model, personalized feedback information and instruction information indicating a next learning step; the processor further configured to estimate an emotional state or load state of the learner using at least the learning activity information and the understanding evaluation information, to generate control information for adjusting a difficulty level and a presentation speed of educational content in accordance with a result of the estimation, and to reflect the control information in at least one of a subsequent prompt sentence to the generative AI model and output control information to the terminal device; and the processor further configured to transmit the feedback information and the instruction information to the terminal device for immediate presentation to the learner, and to store the educational content, the learning activity information, the understanding evaluation information, and the feedback information in association with each other as learning history information for reuse in subsequent prompt sentence generation and educational content generation. This enables an integrated and automated computational pipeline in which raw learner interaction data is transformed into structured evaluation data, which is then used to dynamically control both generative AI prompting and user interface presentation, thereby improving the efficiency, adaptability, and technical performance of the computer-based learning system.

The term “processor” refers to an information processing circuitry, such as a central processing unit, a graphics processing unit, or a combination thereof, that executes instructions to perform data acquisition, data analysis, prompt construction, model invocation, and control of communications with external devices.

The term “generative AI model” refers to an information processing model, implemented for example as a neural network or other machine learning architecture, that generates output data including natural-language text or other content in response to input data including a prompt sentence.

The term “prompt sentence” refers to a data structure including natural-language text or equivalent machine-readable instructions that is provided to the generative AI model to specify a generation task, contextual information, constraints, or desired output characteristics.

The term “educational content” refers to information resources used for learning, including at least problems, explanations, examples, exercises, and guidance materials, which are formatted in text, image, audio, video, or interactive form for presentation to a learner.

The term “learner” refers to a human user who interacts with the system for the purpose of acquiring knowledge or skills, and whose behavior, performance, and state are processed by the system.

The term “attribute information of a learner” refers to information indicating characteristics of the learner, including at least grade level, age range, subject preference, prior knowledge level, or other user profile information.

The term “behavioral information of a learner” refers to information derived from the learner's interactions with educational content, including at least operations performed on a terminal device, answers submitted, navigation actions, and requests for hints or explanations.

The term “terminal device” refers to an electronic apparatus, such as a portable terminal, a desktop terminal, or a display terminal, that executes a client application or browser, receives user input from the learner, and displays educational content and feedback information.

The term “operation information” refers to data indicative of actions performed on the terminal device by the learner, including at least selection of options, text input, button presses, scrolling operations, and navigation commands.

The term “answer information” refers to data representing responses provided by the learner to educational content, including at least selected choices, free-form text answers, numerical responses, and submissions confirming completion of a task.

The term “time-series information” refers to temporal data including timestamps or equivalent temporal markers that indicate times at which the learner performed operations, viewed content, or submitted answers.

The term “learning activity information” refers to structured data obtained by associating the operation information and the answer information with time-series information, thereby representing a sequence of learning-related interactions of the learner.

The term “learning indicators” refers to computed metrics derived from the learning activity information, including at least a number of questions, a number of correct answers, a correctness ratio, a learning time, and a response time, and optionally further indicators such as difficulty-weighted scores and topic-wise performance.

The term “understanding evaluation information” refers to data that represents an evaluated understanding level of the learner, generated from the learning indicators and optionally other information, and used as an input factor for prompt construction and content control.

The term “history information of the learner” refers to accumulated information associated with the learner across multiple sessions, including at least past learning activity information, past understanding evaluation information, past feedback information, and past educational content provided.

The term “personalized feedback information” refers to information generated by the generative AI model that provides guidance, assessment, or recommendations tailored to the specific learner based on the learner's understanding evaluation information and history information.

The term “instruction information indicating a next learning step” refers to information specifying subsequent educational content, topics, difficulty levels, or actions that the learner should undertake following current learning activities.

The term “emotional state of the learner” refers to an estimated affective condition of the learner, such as frustration, engagement, confidence, or boredom, inferred from the learning activity information, understanding evaluation information, or related signals.

The term “load state of the learner” refers to an estimated cognitive or mental workload level of the learner, including at least whether the learner is underloaded, optimally loaded, or overloaded, inferred from interaction patterns and performance indicators.

The term “control information” refers to information used by the processor to adjust system behavior, including at least parameters for difficulty level, presentation speed, content selection, and prompt configuration for the generative AI model.

The term “difficulty level of educational content” refers to a value or category indicating the relative complexity, abstraction, or required prior knowledge of the educational content presented to the learner.

The term “presentation speed of educational content” refers to a parameter controlling a rate or timing with which educational content, feedback, or instructions are displayed or progressed on the terminal device.

The term “output control information” refers to information used to control display, timing, formatting, and sequencing of content and feedback on the terminal device.

The term “learning history information” refers to stored information that associates educational content, learning activity information, understanding evaluation information, feedback information, and related data across one or more sessions for a given learner.

The term “evaluation information” refers to information used to characterize a learning state or performance of the learner, including at least a subject area, a learning unit, a correctness ratio, a learning time, a weak area, and past feedback content.

The term “subject area” refers to a classification of educational content by domain, such as mathematics, language, science, or other academic or skill domains.

The term “learning unit” refers to a subdivision of educational content within a subject area, such as a topic, chapter, lesson, or module.

The term “weak area” refers to a concept, subtopic, or skill in which the learner's performance is lower than a reference level, as determined from the learning indicators or evaluation information.

The term “past feedback content” refers to previously generated feedback information that has been presented to the learner in earlier sessions or activities.

The term “templated sentence structure” refers to a parameterized representation of a sentence or text, including fixed parts and variable parts, into which values derived from evaluation information are embedded to form a concrete prompt sentence.

The term “understanding level represented by a predetermined ratio” refers to a quantitative measure of the learner's understanding expressed as a percentage or other scalar ratio derived from learning indicators.

The term “natural-language response” refers to text generated by the generative AI model in a human language, without requiring additional decoding by a separate machine-level interpreter, and suitable for direct presentation or further processing.

In one embodiment, a server executes a computer program on a hardware platform including at least one central processing unit, a main memory, a non-volatile storage device, and a network interface. The server runs an operating system such as a general-purpose server operating system and a server-side runtime environment such as a general-purpose programming language interpreter. The server further uses data analysis libraries such as a tabular data processing library and a numerical computation library, and communicates with a generative AI model executing on accelerator hardware such as a graphics processing unit or a tensor processing unit.

A terminal operates as a client device. The terminal includes a display, an input device such as a touch screen or keyboard, a local processor, and a communication interface. The terminal runs a web browser or a native application that communicates with the server via a network using a secure transport protocol. The terminal displays educational content and feedback information received from the server, and acquires user input representing answers and navigation actions.

A user interacts with the terminal by reading educational content, entering answers, and selecting operations such as progressing to the next question, requesting a hint, or reviewing feedback. The user's operations produce low-level interaction events that the terminal captures as structured data.

The server manages several data structures stored in a database system, for example a relational database. The server maintains at least: (i) a learner profile table storing learner identifiers, attribute data, and high-level progress information; (ii) a content table storing identifiers, metadata, and difficulty levels of educational content items; (iii) an activity table storing learning activity information; (iv) an evaluation table storing understanding evaluation information; and (v) a feedback table storing feedback information generated by the generative AI model. Each table is indexed on keys such as learner identifier and timestamp to enable efficient retrieval and update.

The server represents learning activity information using a structured record format. For each learner and each content item, the server stores fields including a question identifier, an answer entered by the learner, a correctness flag, timestamps for display and submission, a response time value, and flags indicating hint usage or other actions. The server uses a tabular data structure in memory, such as a data frame, where each row corresponds to a learner-question pair and each column corresponds to a feature such as correctness, response time, and content difficulty.

The server computes learning indicators based on these data structures. The server uses a numerical computation library to aggregate values over subsets of rows corresponding to a particular learner and topic. The server calculates at least: the number of questions attempted, the number of correct answers, a correctness ratio, a total learning time obtained by summing response times, and an average response time. The server may also compute additional indicators such as variance of response times, difficulty-weighted scores, and topic-level accuracy. The server stores these values as understanding evaluation information linked to the learner and the relevant topic.

The server uses this understanding evaluation information, together with history information of the learner, to construct a prompt sentence for the generative AI model. The server maintains a set of templated sentence structures for different use cases, such as feedback generation, next-step recommendation, and summary generation. Each template includes fixed segments and variable segments. The server programmatically fills variable segments with values derived from evaluation information and history information, such as subject name, topic name, correctness ratio, weak areas, and past feedback summaries. The resulting prompt sentence is a natural-language instruction that specifies both the context and the desired output format.

For example, the server generates a prompt sentence in the following form:

“The user is a high school student studying derivatives in mathematics. The user answered 7 out of 10 questions correctly (accuracy 70%). The user's main weak area is the product rule. Generate clear and encouraging feedback in English that: (1) praises what the user already does well, (2) explains why the product rule is important, and (3) suggests concrete practice steps for the next 2-3 study sessions.”

In another example, the server generates a prompt sentence:

“User profile: high school student. Subject: quadratic equations. Accuracy: 80%. The user usually solves standard questions correctly but is slow with word problems. Generate personalized feedback that summarizes the user's current level, identifies weaknesses, and recommends specific next learning materials and practice problems. Answer in no more than 150 words.”

The server communicates with the generative AI model through an application programming interface. The server prepares a request message including at least a role indicating model behavior (such as tutor mode) and the constructed prompt sentence as content. The generative AI model is implemented as a neural network, for example a transformer-based architecture consisting of multiple stacked attention layers, feed-forward layers, normalization blocks, and learned embedding matrices. The server passes input tokens obtained by tokenizing the prompt sentence to the generative AI model.

The generative AI model processes the tokens with self-attention mechanisms and nonlinear transformations. The model uses learned parameters including weight matrices and bias vectors to compute hidden representations and output token probabilities. During training, the model parameters are learned through a gradient-based optimization procedure such as stochastic gradient descent or a variant thereof. The model minimizes a loss function such as cross-entropy between predicted and target tokens on a large corpus of text, optionally including domain-specific educational data. The model's internal computation includes forward propagation, error computation based on the loss function, and backpropagation to update weights. In deployment, the server uses a fixed set of trained parameters and runs only the forward computation to generate an output sequence of tokens corresponding to feedback text or recommendation text.

The server receives the output tokens from the generative AI model, decodes them into characters and words using a tokenizer, and obtains a natural-language response. The response typically includes a feedback message, specific advice, and suggestions for next learning steps. The server may apply post-processing rules, for example truncating responses above a maximum length, removing unsupported markup, or enforcing content filters. The server then stores the generated feedback information in the feedback table, linking it to the corresponding understanding evaluation information and learner profile.

The server also estimates an emotional state or load state of the learner based on the learning activity information and the understanding evaluation information. The server constructs feature vectors per time window, including features such as average response time, change in correctness ratio across blocks of questions, frequency of hint requests, and variation in response patterns. The server applies a classification algorithm, for example a logistic regression model, a decision tree, or a lightweight neural network, trained to map these feature vectors to states such as “underloaded,” “optimal,” or “overloaded.” In another embodiment, the server uses a small neural network with fully connected layers and rectified linear unit activations to infer a load state score between 0 and 1, representing a continuous estimate of cognitive load.

The server uses the estimated state to compute control information. For example, if the load state indicates overload and the correctness ratio is low, the server reduces a difficulty level parameter by selecting content items tagged with lower difficulty values in the content table, or by instructing the generative AI model through the prompt sentence to simplify explanations and reduce complexity. The server also adjusts a presentation speed parameter, such as a time limit or pacing interval, thereby lengthening or shortening time allowed for each question or the rate at which new content is presented. These adjustments are encoded as control information that the server passes either as part of a subsequent prompt sentence or as configuration parameters included in a response message to the terminal.

By structuring the processing in this way, the server improves the technical operation of the computer system. The server uses specific data structures (tabular data frames, indexed database tables, feature vectors) and algorithmic steps (aggregation, feature extraction, model-based estimation) to generate compact, information-rich prompt sentences. This reduces the need to transmit or embed raw interaction logs in the prompts, thereby decreasing communication load and inference latency at the generative AI model. The server's transformation of raw interaction data into structured understanding evaluation information and state estimates allows the generative AI model to focus on generating semantically appropriate feedback rather than inferring basic metrics from unprocessed logs, which improves both accuracy and processing efficiency.

The terminal receives the educational content, feedback information, and control information from the server. The terminal interprets control parameters such as difficulty and pacing to adjust its local user interface behavior. For example, the terminal may show more detailed step-by-step hints when the difficulty parameter is low, or may group questions into longer sets when the parameter indicates a higher tolerance. The terminal schedules the display of content according to presentation speed values, for instance by inserting intentional pauses between screens or automatically advancing after feedback is read. These behaviors involve control of actual hardware display and input timing, thereby tying the abstract computations to specific device operations.

The user experiences a dynamically adapted learning process as a result of this integrated pipeline. The user's responses and behavior influence the learning indicators and state estimates; those indicators and estimates guide prompt sentence construction; the generative AI model responds with tailored feedback and recommendations; and the server and terminal apply control information to alter content difficulty and presentation behavior, resulting in a real-time adaptive system.

In an alternative embodiment, the server executes the generative AI model locally rather than via a remote service. In this case, the server stores model parameters in local non-volatile memory and loads them into memory for inference. The server implements a tokenization module, a transformer inference engine, and a decoding module as separate components. The tokenization module converts the prompt sentence into a sequence of integer token identifiers using a subword vocabulary. The inference engine performs matrix multiplications and attention operations on the tokens using vectorized instructions on the CPU or a GPU. The decoding module selects output tokens according to a sampling or greedy strategy and converts the tokens back into natural-language text.

In another embodiment, the server uses different prompt templates for different types of content. For example, for a summary of a learning session, the server generates a prompt sentence such as:

“Summarize the learner's performance in this session. Subject: mathematics, topic:

derivatives. Correct answers: 7 out of 10. Total learning time: 15 minutes. Main weak area: product rule. Generate a short summary and one key recommendation.”

For a next-step recommendation without explicit feedback, the server generates a prompt sentence such as:

“Based on the learner's performance, recommend the next three topics or exercises to study in mathematics. Current topic: basic derivatives. Accuracy: 70%. Weak areas: product rule. Provide the names of the topics and a brief explanation for each.”

By defining these different templates and algorithmically populating them with evaluation data, the server controls the behavior of the generative AI model in a predictable and efficient manner.

In still another embodiment, the server refines understanding evaluation information using historical information across sessions. The server aggregates multiple sessions for a learner, computes rolling averages of correctness ratio and response time, and detects persistent weak areas using thresholds or statistical tests. The server then embeds this longer-term perspective into the prompt sentence, for example:

“Over the last five sessions, the user's accuracy on derivatives has ranged from 60% to 75%, with persistent weaknesses in the product rule and chain rule. Generate a medium-term learning plan for the next week, including recommended topics and types of practice problems.”

This multi-session integration further enhances the system's ability to adapt over time, and by storing and reusing learning history information in a structured manner, the server reduces the need to recompute features from scratch and improves computational efficiency.

The described embodiments improve computer technology in several respects. The server reduces data volume and processing redundancy by converting raw interaction logs into compact learning indicators and feature vectors before interacting with the generative AI model. This reduces memory usage and network bandwidth during model invocation. The server increases accuracy of feedback and recommendations by explicitly representing weak areas, state estimates, and historical trends in the prompt sentences, rather than relying on the generative AI model to infer such information from long, unstructured logs. The server improves computational efficiency by using optimized numerical libraries for aggregation and feature computation, and by exploiting indexed database structures for fast retrieval of history information. The integrated control loop between evaluation, prompt generation, AI-based feedback, and terminal behavior leads to more responsive and technically effective operation of the overall system, beyond simple automation of human tasks.

The system is not limited to educational applications. The same architecture can be deployed in other domains where a server transforms raw interaction data into structured evaluation information, constructs prompt sentences for a generative AI model, and controls device behavior based on generated feedback. For example, a training system for industrial equipment or a simulation-based practice platform can use the same data structures and program flow, with domain-specific content and indicators. In each case, the server, terminal, and user cooperate to realize an adaptive, technically grounded system in which the computer-implemented processing provides concrete improvements in speed, accuracy, and resource usage.

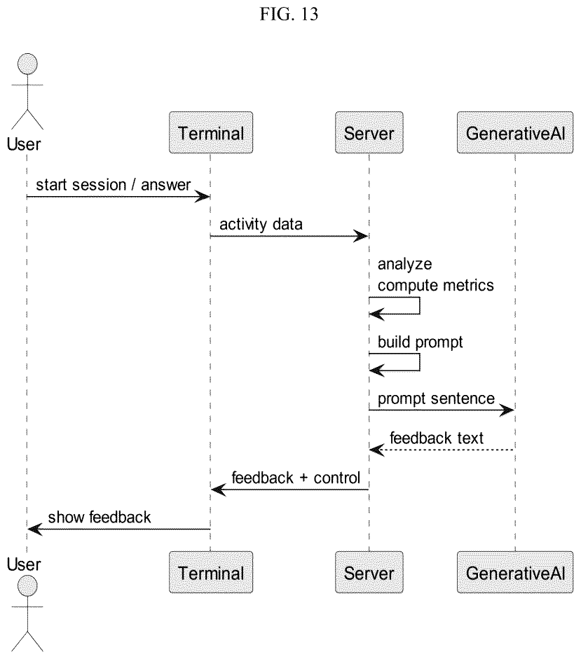

The following describes the processing flow using FIG. 13.

### Step 1:

User operates the terminal to start a learning session and interact with educational content.

User logs in, selects a subject and topic, views questions on the terminal display, and inputs answers using a touch screen, keyboard, or pointing device.

Input: User's physical interactions (taps, clicks, keystrokes, scrolls, answer entries).

Output: Low-level interaction events at the terminal (e.g., “question displayed,” “answer submitted,” “hint requested”).

### Step 2:

Terminal converts the low-level interaction events into structured operation information and answer information.

Terminal assigns timestamps when each question is displayed and when each answer is submitted, identifies the corresponding content item identifier, and records whether the user requested hints or explanations. Terminal computes response time by subtracting the display timestamp from the submission timestamp.

Input: Raw interaction events from user operations.

Output: Structured records including question identifiers, user answers, display timestamps, submission timestamps, response times, and hint usage flags.

### Step 3:

Terminal packages the structured records as learning activity information and transmits them to the server.

Terminal serializes the records into a machine-readable format, associates them with a learner identifier and a session identifier, and sends them via a secure network protocol to a predefined server endpoint.

Input: Structured operation information and answer information with timestamps.

Output: A learning activity dataset transmitted to the server, containing learner ID, session ID, question-level records, and timing data.

### Step 4:

Server receives the learning activity dataset and stores it in persistent storage.

Server validates the data format, checks required fields, and inserts the records into an activity table in a database, indexing them by learner identifier, session identifier, and timestamp.

Input: Learning activity dataset received from the terminal.

Output: Persisted learning activity information stored as rows in one or more database tables, ready for analysis.

### Step 5:

Server loads the stored learning activity information into an in-memory tabular data structure for analysis.

Server queries the database for records matching a given learner and topic, converts the retrieved rows into a data frame, and normalizes data types for numeric and categorical fields.

Input: Persisted activity records in the database.

Output: An in-memory data frame representing learning activity information with columns for correctness, response time, content identifiers, and other features.

### Step 6:

Server computes learning indicators from the in-memory learning activity information.

Server performs aggregation operations to count the number of questions, count the number of correct answers, compute correctness ratio as a percentage, sum response times to obtain total learning time, and divide by the number of questions to obtain average response time.

Server may also compute additional metrics such as variance of response times and topic-wise accuracy.

Input: Data frame representing learning activity information.

Output: A set of learning indicators for the learner and topic, including at least number of questions, number of correct answers, correctness ratio, total learning time, and average response time.

### Step 7:

Server generates understanding evaluation information based on the learning indicators and, optionally, content metadata.

Server maps raw metrics to an understanding level score, identifies weak areas by comparing performance across subtopics, and assigns categorical labels such as “low,” “medium,” or “high” understanding. Server constructs a structured evaluation object that includes these values.

Input: Learning indicators and content metadata (e.g., tags for subtopics and difficulty).

Output: Understanding evaluation information for the learner, including numerical scores, weak area lists, and categorical understanding levels.

### Step 8:

Server retrieves history information of the learner and refines the evaluation.

Server queries past evaluation records and feedback records for the same learner and topic, and computes rolling averages or trends, such as changes in correctness ratio over multiple sessions. Server updates the current evaluation to incorporate this historical context.

Input: Current understanding evaluation information and historical evaluation and feedback data.

Output: Refined understanding evaluation information that reflects both current session performance and multi-session trends.

### Step 9:

Server estimates an emotional state or load state of the learner from the activity and evaluation data.

Server extracts features such as average response time, change in accuracy between question blocks, frequency of hint requests, and number of consecutive incorrect answers. Server applies a predictive model or rule set to classify the learner state (e.g., “underloaded,” “optimal,” or “overloaded”) or to compute a continuous load score.

Input: Learning activity information, understanding evaluation information, and optionally historical patterns.

Output: An estimated state indicator for the learner, representing emotional state or cognitive load.

### Step 10:

Server generates control information for difficulty level and presentation speed based on the estimated state and evaluation.

Server applies decision logic to adjust parameters: for example, if correctness ratio is low and load state indicates overload, server decreases difficulty and slows presentation speed; if correctness ratio is high and load state indicates underload, server increases difficulty and speeds up presentation.

Input: Refined understanding evaluation information and estimated state indicator.

Output: Control information specifying target difficulty level, presentation speed, and possibly preferred content types for subsequent educational content.

### Step 11:

Server constructs a prompt sentence for the generative AI model using a templated structure.

Server selects a template based on the task (e.g., feedback generation or next-step recommendation), then fills variable fields with values from the evaluation information, weak areas, learning time, and control information. Server produces a natural-language instruction that constrains length, tone, and content focus.

Input: Refined understanding evaluation information, estimated state, control information, and learner profile.

Output: A fully constructed prompt sentence describing learner status and specifying what the generative AI model should generate.

### Step 12:

Server sends the prompt sentence to the generative AI model and requests generation of feedback and instruction information.

Server tokenizes the prompt sentence, packages it into a model request, and transmits it to the generative AI model running on accelerator hardware. The model performs forward propagation through its network layers to compute output token probabilities and generates a natural-language response.

Input: Prompt sentence and configuration parameters (e.g., temperature, maximum length).

Output: A natural-language response from the generative AI model, including feedback information and suggested next learning steps.

### Step 13:

Server decodes and post-processes the natural-language response into structured feedback information.

Server converts output tokens to text, checks for length and content constraints, and optionally segments the response into components such as summary, detailed explanation, and recommended actions. Server then constructs a feedback object that contains these components in a structured format.

Input: Natural-language response from the generative AI model.

Output: Structured feedback information and instruction information ready for storage and delivery to the terminal.

### Step 14:

Server stores the feedback information together with related data as learning history information.

Server inserts a record into the feedback table associating the learner ID, evaluation ID, timestamp, feedback text, and model parameters used. Server maintains links between stored feedback, understanding evaluation information, and original learning activity information, enabling future reuse.

Input: Structured feedback information, understanding evaluation information, and references to activity records.

Output: Updated learning history information persisted in the database.

### Step 15:

Server generates a response message for the terminal, incorporating feedback, control parameters, and any updated content selection.

Server embeds feedback text, recommended next topics or exercises, difficulty level, and presentation speed values into a response structure. If needed, server also selects specific content item identifiers for the next session based on control information and content metadata.

Input: Feedback information, control information, and content metadata.

Output: A response message containing displayable feedback and configuration parameters for the terminal.

### Step 16:

Terminal receives the response message and updates its user interface and behavior.

Terminal parses the response, extracts feedback text, recommended actions, difficulty level, and presentation speed. Terminal configures its display logic to show the feedback message, adapts the format (for example, highlighting weak areas), and sets internal timers or limits based on the presentation speed.

Input: Response message from the server with feedback and control information.

Output: Updated UI state on the terminal, including rendered feedback text and adjusted pacing or difficulty for subsequent content.

### Step 17:

User views the feedback and follows the recommended next steps on the terminal.

User reads the feedback text, recognizes indicated strengths and weaknesses, and selects an action such as “review basic derivatives” or “start a new quiz.” User's selection initiates a new round of content retrieval and interaction, which the terminal again records and sends to the server.

Input: Feedback and options presented on the terminal display.

Output: New user interactions that become the next cycle of learning activity information for the server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented learning systems and training systems are typically configured to deliver pre-authored content and to perform simple scoring of user responses. Such systems generally rely on static rule sets and fixed difficulty progressions, and thus are unable to adapt their behavior in a fine-grained manner to a learner's evolving comprehension, emotional state, or operational skill in real time. As a result, these systems often suffer from suboptimal allocation of content, unsuitable pacing, and ineffective feedback presentation, which degrades overall learning efficiency and user engagement.

In many existing architectures, a processor in a learning server simply retrieves content identifiers from a database, pushes the corresponding content to a terminal, and logs correctness scores. Emotional signals from cameras, microphones, or biometric sensors, if used at all, are processed in an isolated manner and are not fused with learning performance data in a unified computational model. Generative models, when employed, are typically invoked in an ad hoc fashion to generate explanations or hints, without a systematic mechanism for programmatically constructing prompt sentences based on integrated learner profiles, emotional logs, and task histories. Consequently, these systems fail to exploit the full potential of generative models for adaptive content generation and dynamic strategy optimization.

Furthermore, existing systems generally lack a robust framework for continuously tuning the behavior of the learning platform itself. Aggregated performance metrics, emotional trends, and operation history data are rarely used as inputs to machine-oriented control logic that adjusts the server's own configuration parameters, such as difficulty adjustment rules, session timing, or prompt generation templates. Instead, such parameters are fixed or manually tuned by developers or instructors, leading to rigid, non-scalable solutions. This limitation is particularly problematic in industrial training scenarios, where an industrial worker's operation history and skill evaluation data must be reflected quickly in updated procedure content and safety instructions presented on visual display devices in real work environments.

From a computer-technology perspective, therefore, there is a need for an improved server architecture and processing method that: (i) programmatically constructs prompt sentences for a generative AI model based on a unified learner profile that includes learning history, comprehension indicators, and emotional state; (ii) invokes the generative AI model as a core computation engine to generate educational or training content, feedback, and strategy recommendations; (iii) dynamically adjusts content difficulty, presentation order, and session timing based on real-time analysis results; and (iv) iteratively updates its own internal control parameters by feeding aggregated state data back into the generative AI model. Such an architecture should improve the functioning of the computer system itself by enabling context-aware orchestration of content generation and feedback loops across heterogeneous data sources (learning data, emotion data, and operation history data), rather than merely automating human teaching practices.

The specific processing by the specific processing unit 290 of the data processing device 12 in Application Example 2 is realized by the following means.

The present invention provides a server comprising a processor configured to acquire learning history information, learning tendency information, and learning objective information from a storage device, generate learner profile data representing an ability characteristic and a comprehension level of a learning subject based on the acquired information, recognize, in real time and in association with time information, an emotional state of the learning subject by performing emotion estimation processing using image information, audio information, or biometric information obtained from a terminal device, associate and store the emotional state with the learner profile data, generate prompt sentences for a generative information processing apparatus based on at least the learner profile data and the emotional state so as to cause the generative information processing apparatus to generate or select educational content data or training content data adapted to the learning subject, further generate prompt sentences for causing the generative information processing apparatus to analyze evaluation data sets including the educational content data or the training content data, answer data and answer time information, obtain comprehension indicators and feedback information as analysis results, dynamically adjust, based on the comprehension indicators, the emotional state, and the learner profile data, at least one of a difficulty level, a presentation order, and a time allocation of a learning or training session by successively providing update prompt sentences to the generative information processing apparatus, transmit the feedback information and reassurance message information or relaxation audio information generated in accordance with the emotional state to the terminal device for immediate presentation, and, in a training context, obtain operation history data and skill evaluation data regarding an industrial worker or a machine, generate prompt sentences for the generative information processing apparatus based on the operation history data and the skill evaluation data so as to cause the generative information processing apparatus to generate training content data including procedure information for work training, and transmit the training content data to a visual display device for sequential presentation in a real work environment. This enables the computer system itself to perform unified, context-aware control of adaptive content generation and feedback by using the generative information processing apparatus as a core computation engine, to dynamically optimize difficulty, pacing, and instructional strategy based on integrated learner profiles, emotional logs, and operation histories, and to improve the technical performance of the learning and training platform in terms of responsiveness, personalization granularity, and automated configuration of instructional behavior.

The term “processor” refers to an information processing circuitry, such as a central processing unit or other computing hardware element, that executes instructions to perform the functions described in the present disclosure.

The term “storage device” refers to a hardware component capable of storing digital data, such as a memory device or a persistent storage device, that retains learning history information, learning tendency information, learning objective information, operation history data, skill evaluation data, and related information.

The term “learning subject” refers to a person or user who receives educational content or training content and whose ability characteristic, comprehension level, and emotional state are analyzed by the system.

The term “learning history information” refers to data indicating past learning activities of the learning subject, including at least one of completed content identifiers, scores, response times, usage frequencies, timestamps, and other learning performance records.

The term “learning tendency information” refers to data indicating patterns or preferences in the learning subject's behavior, including at least one of preferred content formats, typical response patterns, topic preferences, and learning style indicators derived from learning history information.

The term “learning objective information” refers to data indicating one or more learning goals of the learning subject, including at least one of target topics, desired proficiency levels, time constraints, and curriculum requirements.

The term “learner profile data” refers to data generated by the processor that represents an integrated characterization of the learning subject, including at least one of an ability characteristic, a comprehension level, a topic-wise strength or weakness, and associated emotional state information.

The term “ability characteristic” refers to an attribute of the learning subject that indicates a capability level in one or more knowledge domains or skill domains, derived from analysis of learning history information and other performance data.

The term “comprehension level” refers to an indicator representing how well the learning subject understands a particular topic, concept, or procedure, and may include quantitative or qualitative measures obtained from analysis of answer data and evaluation data sets.

The term “terminal device” refers to a user-side computing apparatus, such as a mobile device, a tablet, a personal computer, or a wearable device, that acquires information from the learning subject and presents content, feedback, or messages to the learning subject.

The term “image information” refers to data representing visual information captured by an image acquisition apparatus, such as a camera, including at least one of facial images, body posture images, and other visual cues related to the learning subject.

The term “audio information” refers to data representing sound acquired by an audio acquisition apparatus, such as a microphone, including at least one of voice signals, tone of voice, and other acoustic features related to the learning subject.

The term “biometric information” refers to data representing physiological or biological signals of the learning subject, including at least one of heart rate, skin conductance, respiration, and other sensor-derived signals that can be used for emotion estimation.

The term “emotion estimation processing” refers to processing that analyzes image information, audio information, or biometric information to infer an emotional state of the learning subject, such as stress, relaxation, boredom, engagement, anxiety, or confidence.

The term “emotional state” refers to a psychological or affective condition of the learning subject at a given time, including at least one of stress, relaxation, boredom, engagement, anxiety, fear, joy, and motivation, and is recognized by emotion estimation processing.

The term “generative information processing apparatus” refers to a computation system that implements a generative AI model and is configured to receive a prompt sentence as input and generate output data such as educational content data, training content data, feedback information, or recommendation information.

The term “generative AI model” refers to a machine learning model, such as a neural network-based language model or other generative model, which generates text or structured data outputs in response to an input prompt sentence.

The term “prompt sentence” refers to a text-based instruction or query, generated by the processor, that specifies a task, context, or constraints for the generative information processing apparatus, and guides the content and format of the output produced by the generative AI model.

The term “educational content data” refers to data representing content for learning, including at least one of explanations, examples, problems, hints, diagrams, and other instructional materials adapted to the learning subject.

The term “training content data” refers to data representing content for training practical skills, including at least one of step-by-step procedures, operation instructions, safety notices, checklists, and other materials adapted to an industrial worker or machine operation.

The term “evaluation data set” refers to a collection of data including at least the educational content data or the training content data, answer data from the learning subject, and answer time information, which is provided to the generative information processing apparatus for analysis.

The term “answer data” refers to data representing responses of the learning subject to educational content data or training content data, including at least one of selected options, free-form input, numerical answers, and procedural confirmations.

The term “answer time information” refers to data indicating time measurements associated with answers of the learning subject, including at least one of start times, end times, and total response durations for one or more tasks.

The term “comprehension indicator” refers to data obtained as an analysis result from the generative information processing apparatus, indicating a degree of understanding of the learning subject with respect to a particular content item, topic, or skill.

The term “feedback information” refers to data generated based on analysis of evaluation data sets, including at least one of correctness judgments, explanatory messages, hints, improvement suggestions, and recommended next steps for the learning subject.

The term “difficulty level” refers to a parameter representing a relative complexity or challenge of educational content data or training content data, which can be increased, decreased, or otherwise adjusted by the processor.

The term “presentation order” refers to a sequence in which educational content data or training content data is provided to the learning subject or industrial worker, and can be dynamically rearranged based on analysis results.

The term “time allocation” refers to a distribution or setting of time for a learning session or training session, including at least one of total session duration, per-task duration, and rest intervals.

The term “update prompt sentence” refers to a prompt sentence generated after an initial analysis or session, which reflects updated learner profile data, emotional states, comprehension indicators, or operation histories, and is used to cause the generative information processing apparatus to generate new or modified content.

The term “reassurance message information” refers to data representing one or more text messages or other communicative content designed to reduce anxiety or fear and to encourage the learning subject or industrial worker during learning or training.

The term “relaxation audio information” refers to data representing audio content intended to promote relaxation of the learning subject or industrial worker, such as calming sounds, music, or guided relaxation audio.

The term “operation history data” refers to data indicating past operations performed by an industrial worker or a machine, including at least one of task identifiers, execution sequences, timestamps, error events, and performance metrics.

The term “skill evaluation data” refers to data representing assessments of a skill level of an industrial worker or performance level of a machine, including at least one of test results, checklist evaluations, observed error types, and proficiency ratings.

The term “procedure information” refers to data describing step-by-step actions, instructions, or processes that an industrial worker should execute in a training or work context.

The term “visual display device” refers to a device capable of visually presenting content in a work environment, such as a head-mounted display, smart glasses, monitor, or other image display apparatus.

The term “individual learning plan data” refers to data representing a structured plan for future learning activities of the learning subject, including at least one of recommended topics, content types, difficulty levels, schedules, and pacing instructions.

The term “state data” refers to data representing a condition of a learning subject, an industrial worker, or a machine, including at least one of emotional state, comprehension indicator, learning history information, operation history data, and related contextual information.

The term “recommendation information” refers to data generated by the generative information processing apparatus that indicates an adjustment policy for an educational strategy or a training strategy, including at least one of content selection rules, pacing guidelines, and difficulty adjustment rules.

The term “generation rule of the prompt sentence” refers to a set of conditions, templates, or parameters used by the processor to construct a prompt sentence to be input to the generative information processing apparatus.

The term “difficulty adjustment condition” refers to a criterion or set of criteria used by the processor to determine when and how to change the difficulty level of educational or training content based on one or more indicators.

The term “session time setting” refers to a configuration parameter that specifies time-related constraints or preferences for learning or training sessions, including at least one of maximum session duration, per-task limits, and timing for breaks.

In one or more embodiments, a server, a terminal, and a networked generative information processing apparatus cooperate to implement an adaptive learning and training system that generates educational content data and training content data using a generative AI model in response to programmatically constructed prompt sentences. The system uses specific hardware components, defined data structures, and defined software modules to improve the functioning of the computer platform, including more efficient data processing, reduced communication overhead, and higher accuracy of personalization, beyond what is achievable by simple rule-based or manual configuration.

### A. SYSTEM ARCHITECTURE

The server includes at least one processor, a main memory, a non-volatile storage device, and a network interface. The processor is, for example, a general-purpose central processing unit or a specialized computing device. The memory stores executable instructions for modules described below. The storage device stores databases including a learner database, a content database, an emotion log database, and an operation history database.

The terminal includes at least one processor, a display device, one or more input devices (such as a touch panel or keyboard), and one or more sensors, such as a camera, a microphone, and optionally biometric sensors (for example, a heart-rate sensor). The terminal executes a client application that communicates with the server via a communication network.

The generative information processing apparatus is a computing resource that executes a generative AI model. In one embodiment, the generative AI model is a neural-network-based language model with a transformer architecture having multiple self-attention layers, feed-forward layers, and output layers. The generative information processing apparatus receives a prompt sentence as input text and outputs one or more text sequences representing educational content data, training content data, or feedback information.

### B. DATA STRUCTURES AND STORED INFORMATION

The server stores learning history information, learning tendency information, and learning objective information for each learning subject in the learner database. The server stores these items in structured records, for example:
Learning history information: records indexed by learner ID and content ID, including fields such as score (numeric), correctness flags (Boolean array), response time (floating-point representation in seconds), timestamps (time values), and content type tags.
Learning tendency information: summary records including fields such as preferred content modality (categorical field with values such as visual, textual, auditory), average time per content type, difficulty tolerance scores, and topic interest scores.
Learning objective information: records including target topic identifiers, desired proficiency levels, time budgets, and curriculum constraints.

The server generates and stores learner profile data as aggregated records that include, for each learner, ability characteristics per topic (for example, normalized proficiency scores), comprehension levels (for example, per-skill scalar values), and links to emotional state data.

The server stores emotional state data in the emotion log database. Each entry includes learner ID, timestamp, emotional state label (e.g., relaxed, stressed, engaged, bored), confidence score, and sensor context (e.g., camera only, camera+microphone, biometric sensor).

The server stores operation history data and skill evaluation data for industrial workers or machines in the operation history database. Each record includes worker ID or machine ID, operation type, task sequence data, error event data, duration, and skill rating values.

### C. EMOTION ESTIMATION AND LEARNER PROFILE GENERATION

The terminal uses the camera and microphone to capture image information and audio information related to the learning subject. The terminal uses an emotion estimation module to extract features from these signals. For example, the terminal uses a convolutional neural network to extract facial expression features from image frames, and a recurrent or transformer-based model to extract prosodic features from audio signals. The terminal converts these features into an emotional state prediction by applying a classifier trained with supervised learning.

The server receives the emotional state data from the terminal and stores it in the emotion log database. The server correlates the emotional state data with the learner profile data by matching timestamps and task identifiers.

The server uses software such as a numerical computation library and a data analysis library (for example, a general-purpose array processing library and a table-processing library) to compute statistical summary features from learning history and emotional logs, such as moving average performance per topic, standard deviation of response times, frequency of stress events during particular content types, and correlation between difficulty level and emotional state.

The server generates learner profile data by combining these statistical features into a structured representation. In one embodiment, the server encodes the learner profile as a feature vector with components such as topic-wise proficiency, content-modality preference scores, emotional stability indicators, and recent trend indicators. The server uses this vector both to adjust system-level parameters and to construct prompt sentences.

### D. GENERATIVE AI MODEL CONFIGURATION AND LEARNING

The generative AI model is implemented as a multi-layer transformer neural network. The server configures the generative information processing apparatus with a vocabulary, tokenization method, and hyperparameters such as number of layers, number of attention heads, hidden dimension size, and maximum sequence length.

The generative AI model is trained on a corpus of educational text, procedural instructions, and dialogue-style feedback data. During training, the generative AI model uses a loss function, such as a cross-entropy loss over token predictions, and is optimized using gradient-based optimization (for example, stochastic gradient descent or a variant with adaptive learning rates). The model parameters are updated by computing gradients of the loss with respect to model weights and applying updates with a chosen learning rate schedule.

The server in some embodiments further fine-tunes the generative AI model on domain-specific data: for example, math problem statements and step-by-step solutions, industrial training manuals, and human-generated feedback annotations. The server uses fine-tuning data sets where each training example includes an input prompt and a desired output text. By fine-tuning, the generative AI model improves its ability to respond accurately and contextually to the system's prompt sentences.

### E. PROMPT SENTENCE CONSTRUCTION AND DATA PROCESSING

The server uses a prompt generation module that constructs prompt sentences based on learner profile data, emotional states, and evaluation data sets. Rather than using static templates, the server uses rule sets and algorithms that select which attributes to include and how to phrase them, depending on system state.

For example, the server generates prompt sentences of the following kind for initial content generation:
“This learner is weak in basic differentiation and is currently slightly stressed. Please generate a gentle introduction to the concept of derivatives using simple visual analogies and include two very easy practice problems.”

For answer evaluation and feedback generation, the server constructs prompt sentences that embed problem text, correct answers, user answers, and context:
“Please evaluate the learner's answer to the following mathematics problem and generate feedback based on the learner's level of understanding.

Problem: [problem text]

Correct answer: [correct answer]

Learner's answer: [user answer]

The learner has struggled with similar problems before and is currently slightly anxious.

Provide: (1) a correctness judgment, (2) an explanation suitable for a beginner, and (3) one hint for a similar follow-up problem.”

For industrial training scenario content generation, the server uses prompts such as:
“Please generate a step-by-step robot operation training program tailored to a new worker with the following skill profile and error history: [skill profile and errors]. Include clear instructions, safety warnings, and checkpoints to verify understanding.”

The server encodes these prompt sentences as text strings and transmits them over a network interface to the generative information processing apparatus. The server receives output text, token sequences, or structured text fragments from the generative AI model and converts them to educational content data or training content data.

### F. ALGORITHMIC FLOW AND TECHNICAL EFFECTS

The server uses the generative AI model as a core computation engine, guided by programmatic prompt generation, to determine both the content to present and the strategy for presentation. The server does not simply replace a human author; instead, the server performs operations that are not practically feasible by manual means with the same speed or accuracy.

The server uses specific algorithms to reduce the dimensionality of learner data and to compress it into prompt sentences. For example, the server uses clustering methods or principal component analysis on the learner profile feature vectors to identify typical learner states, thereby avoiding excessive detail and reducing the size of prompt sentences. This compression reduces communication load between the server and the generative information processing apparatus while preserving the key features that drive personalization.

The server applies rule-based transformations on the output of the generative AI model. For instance, the server parses the generated text, identifies headers, lists, and problem statements using pattern recognition, and maps them into structured objects with explicit fields (e.g., explanation, example, practice problem, solution). By doing this structuralization, the server can store and retrieve content more efficiently, and can reuse or recombine components when generating future prompts.

The server improves processing speed relative to purely rule-based content systems by delegating complex natural-language generation to the generative AI model while confining deterministic logic to lightweight feature extraction and prompt construction. The server reduces latency by caching frequent prompt-output pairs and by precomputing learner-state-to-prompt mappings using a lookup table or learned mapping model.

The server improves personalization accuracy by explicitly incorporating emotional state and operation history data into prompt sentences. Conventional systems either ignore these signals or treat them as external to the core content engine. The server, in contrast, integrates these signals into a unified computational process, where the generative AI model receives explicit mentions of stress, boredom, or specific industrial errors, enabling the model to tailor explanations, warnings, and pacing in a way that is not reachable by generic static prompts.

### G. INDUSTRIAL TRAINING INTEGRATION AND EQUIPMENT CONTROL

The server uses operation history data and skill evaluation data not only to display training information but also to coordinate with visual display devices such as smart glasses or head-mounted displays. In one embodiment, the server segments generated training content data into procedural steps, each associated with an identifier and relevant sensor conditions.

The server transmits step-wise training content to the visual display device. The terminal or visual display device overlays instructions in the worker's field of view, synchronizing content presentation with detected progress from sensors (e.g., worker position, interaction with machine controls). The server receives confirmations or sensor-derived events, and automatically advances to the next step or repeats the current one based on pre-defined rules and feedback from the generative AI model.

The server thereby contributes to improved safety and efficiency in real work environments. Because the content generation, selection, and step advancement are controlled algorithmically based on operation history and emotional state, the training session adapts to the worker's current skill and comfort level, reducing error probability and training time.

### H. LEARNING STRATEGY OPTIMIZATION

The server periodically aggregates state data, including emotional states, comprehension indicators, and operation histories, over a time window. The server generates higher-level prompt sentences describing these aggregates:
“Given the following aggregated performance and emotion data for this learner, please recommend adjustments to teaching strategies, such as content type balance, pacing, and difficulty progression: [aggregated metrics].”

The generative AI model outputs recommendation information indicating adjustments, such as increasing visual content, reducing session length, or shifting problem distribution across topics. The server converts these recommendations into updates of internal configuration parameters:
adjustment of difficulty thresholds used to classify tasks as easy, moderate, or hard;
modification of session time settings, such as maximum continuous learning duration or break intervals;
changes in prompt generation rules, such as explicitly requesting more step-by-step explanations or more diagnostic questions.

By using this feedback loop, the server improves its own internal configuration without human intervention. The system thus evolves over time to better match learner population characteristics, improving accuracy and reducing the need for manual tuning.

### I. TECHNICAL IMPROVEMENT AND NON-CONVENTIONAL USE OF AI

The server uses the generative AI model in a constrained, rule-driven manner, rather than simply delegating all decisions to an opaque model. The server performs feature extraction, learner-state classification, and rule-based prompt construction before invoking the generative AI model. This architecture yields several technical effects:
Improved computational efficiency: The server sends only compact, high-information prompt sentences to the generative information processing apparatus, rather than raw logs or full data sets, thereby reducing data transmission volume and processing overhead on the generative AI side.
Improved accuracy: The server includes in the prompt sentence only features that have been shown, through offline analysis, to be predictive of learner needs or worker performance. This targeted conditioning increases the relevance of generated content relative to generic prompt use.
Reduced latency and communication load: The server caches generated content and reuses it when similar learner states recur, avoiding repeated calls to the generative AI model, which reduces network latency and computational cost.
Enhanced fault tolerance: The server verifies generated text structurally and semantically (for example, checking that a generated problem includes a clear question and an answer) and rejects or flags invalid outputs, then regenerates content with modified prompt sentences.

This two-step control is not present in simple generative text applications.

The described system thus goes beyond automation of human teaching behavior. The server implements a computational control layer that shapes model inputs and interprets model outputs in a technical manner designed to optimize system resources and reliability.

### J. ALTERNATIVE EMBODIMENTS

In one embodiment, the terminal performs a larger portion of emotion estimation processing locally, using a compressed version of the emotion recognition model. The terminal then sends only emotional state labels and associated metadata to the server. This reduces uplink bandwidth and offloads part of the computation from the server.

In another embodiment, the server uses different generative models for different tasks. For example, one generative AI model specialized for mathematical explanations and another model specialized for industrial instructions. The server selects which model to address with the prompt sentence based on topic or scenario. The server can also use a model-ensemble strategy, where multiple models generate candidate content and the server selects among them using scoring rules or a separate discriminative model.

In yet another embodiment, the server uses an additional machine learning model to map learner profile vectors directly to parameters of the prompt generation process. For example, the server uses a smaller neural network to determine whether emotional state information should be explicitly mentioned in the prompt sentence or encoded implicitly through difficulty-level descriptions. This meta-model increases flexibility and can be updated independently of the generative AI model.

In a further embodiment, the server stores learner profile data and content references in a graph-structured database, in which nodes represent learners, content items, and skills, and edges represent relationships (e.g., uses, improves, confuses with). The server uses graph algorithms, such as shortest-path or centrality measures, to select content that connects a current skill state to a desired objective with minimal steps, and then uses prompt sentences to ask the generative AI model to fill in missing explanations or bridge problems.

Through these and other variations, the server, the terminal, and the generative information processing apparatus cooperate to implement the claimed system, enabling concrete, technically grounded improvements in computer-implemented learning and training, including adaptive content generation, emotion-aware pacing, and industrial procedure guidance.

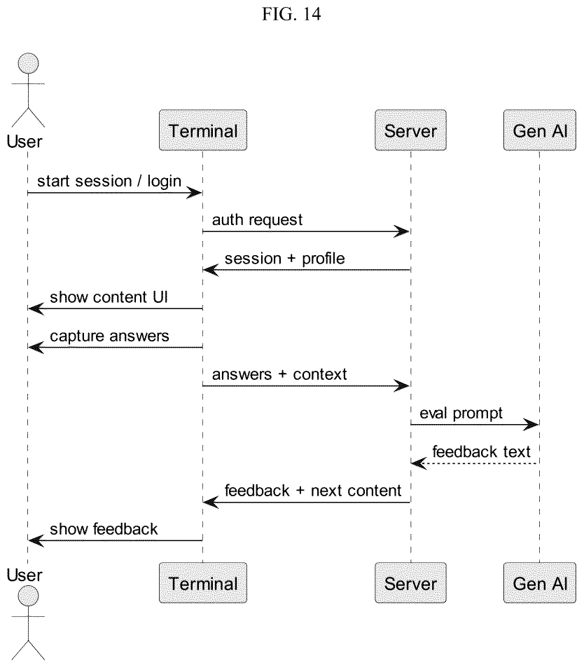

The following describes the processing flow using FIG. 14.

### Step 1:

The user starts a learning or training session on the terminal.

The terminal receives a user identifier, authentication information, and optionally initial selections such as a target topic or training scenario. As input, the terminal uses user credentials and a selected task identifier. The terminal sends these items via a communication interface to the server as a login request. As output, the terminal provides a structured login request message containing the user identifier and selected task information.

### Step 2:

The server authenticates the user and retrieves base profile data.

The server receives the login request message as input. The server compares the received authentication information with records stored in a user database on a storage device and, if valid, retrieves learning history information, learning tendency information, and learning objective information associated with the user identifier. The server aggregates these records into a learner profile template. As output, the server generates a learner profile record containing at least topic-wise scores, usage statistics, and declared goals, and returns a session token and a summary profile to the terminal.

### Step 3:

The terminal initializes sensing and interface components.

The terminal receives the session token and the summary profile from the server as input. The terminal activates a camera, a microphone, and, if available, biometric sensors. The terminal initializes user interface components, such as a dashboard and content placeholders, based on the summary profile. As output, the terminal produces a local session state including active sensor flags, UI layout configuration, and a reference to the server session token.

### Step 4:

The terminal acquires raw emotion-related signals.

The terminal uses the active sensors to capture image information of the user's face, audio information of the user's voice, and biometric information such as heart rate. As input, the terminal uses sensor hardware readings sampled at defined intervals. The terminal preprocesses these signals by down-sampling frames, normalizing audio levels, and filtering noise. As output, the terminal generates batches of preprocessed image frames, audio segments, and biometric vectors annotated with timestamps.

### Step 5:

The terminal estimates an emotional state from sensor data.

The terminal uses the preprocessed sensor batches as input to an emotion estimation module.

The terminal applies a trained neural network classifier that extracts features from the image frames and audio segments and maps them to emotion labels such as relaxed, stressed, engaged, or bored, with confidence scores. The terminal also considers biometric vectors as additional features. As output, the terminal generates emotional state records that include a learner identifier, a timestamp, an emotion label, and a confidence value.

### Step 6:

The terminal transmits emotional state records to the server.

The terminal uses the emotional state records as input and packages them with the session token. The terminal sends these records to the server over the network at configured intervals.

As output, the terminal generates an emotion update message that the server can store and correlate with learning events.

### Step 7:

The server updates learner profile data with emotional information.

The server receives the emotion update message as input. The server writes each emotional state record into an emotion log database and links it to the learner identifier and the current task identifier stored in the session. The server computes rolling statistics, such as the frequency of stress events per topic and the average emotion label during recent sessions, by applying aggregation functions over the emotion log. As output, the server generates an updated learner profile data structure that includes both performance-related attributes and emotional state attributes.

### Step 8:

The server prepares an initial prompt sentence for content generation.

The server uses the updated learner profile data and, if applicable, a selected topic or training scenario as input. The server applies a rule-based prompt construction algorithm that selects which profile attributes to mention explicitly, such as weaknesses, current emotion, and time constraints. The server then constructs an initial prompt sentence in natural language for a generative AI model, for example: “This learner is weak in basic differentiation and is currently slightly stressed. Please generate a gentle introduction to the concept of derivatives using simple visual analogies and include two very easy practice problems.” As output, the server produces a text prompt sentence ready to be sent to the generative information processing apparatus.

### Step 9:

The server requests educational content from the generative AI model.

The server uses the constructed prompt sentence as input and submits it to the generative information processing apparatus via an API call. The generative AI model tokenizes the prompt, processes it through a transformer architecture, and predicts a sequence of output tokens that represent an explanation, examples, and practice problems. As output, the generative information processing apparatus returns a text response that encodes educational content data adapted to the learner profile.

### Step 10:

The server parses and structures generated educational content.

The server receives the text response from the generative information processing apparatus as input. The server executes a content parser that identifies sections such as titles, explanations, examples, and practice problems by searching for patterns such as numbered lists or “Problem:” prefixes. The server maps these sections into a structured content object with fields for explanation text, problem statements, and, if present, reference answers. As output, the server produces an educational content data object that can be stored and transmitted efficiently.

### Step 11:

The server sends educational content data to the terminal.

The server uses the structured educational content data object as input. The server encapsulates this object into a response message with the session token and transmits it to the terminal via the network interface. As output, the server provides a content delivery message that includes all information necessary for presentation.

### Step 12:

The terminal renders educational content and initializes answer collection.

The terminal receives the content delivery message as input. The terminal populates its user interface with the explanation text and problem statements, generating appropriate input widgets such as multiple-choice controls or text fields. The terminal associates each widget with a problem identifier. As output, the terminal produces a displayed content screen and an internal mapping from problem identifiers to input fields for subsequent answer collection.

### Step 13:

The user studies the content and inputs answers.

The user observes the explanation and interacts with the terminal interface as input. The user enters answers into the provided input fields and confirms submission. As output, the user generates answer values corresponding to each problem statement.

### Step 14:

The terminal compiles answer data and timing information.

The terminal receives the user's answer events and associated timestamps as input. The terminal calculates per-problem response time by subtracting problem presentation time from submission time. The terminal compiles an answer data set that includes the problem identifiers, the user's answers, and the computed response times. As output, the terminal generates an answer package containing both answer data and answer time information.

### Step 15:

The terminal sends the answer package to the server.

The terminal uses the answer package and the session token as input and transmits them to the server. As output, the terminal produces an answer submission message, which the server receives for evaluation.

### Step 16:

The server prepares an evaluation prompt sentence for the generative AI model.

The server receives the answer submission message and the corresponding educational content data as input. The server optionally performs basic checks, such as numeric comparison or simple pattern matching, to compute initial correctness flags. The server then constructs an evaluation prompt sentence that includes the problem text, the correct answer if available, the learner's answer, any known prior difficulties, and the current emotional state.

An example is: “Please evaluate the learner's answer to the following mathematics problem and generate feedback based on the learner's level of understanding. Problem: [problem text] Correct answer: [correct answer] Learner's answer: [user answer] The learner has struggled with similar problems before and is currently slightly anxious. Provide: (1) a correctness judgment, (2) an explanation suitable for a beginner, and (3) one hint for a similar follow-up problem.” As output, the server produces a detailed evaluation prompt sentence.

### Step 17:

The server requests feedback information from the generative AI model.

The server uses the evaluation prompt sentence as input to the generative information processing apparatus. The generative AI model processes the prompt, using its learned parameters to generate a textual response that includes a correctness judgment, an explanation, and a hint. As output, the generative information processing apparatus returns a feedback response text.

### Step 18:

The server extracts a comprehension indicator and feedback from the response.

The server receives the feedback response text as input. The server analyzes the text to detect a stated correctness judgment (e.g., “correct” or “incorrect”), extracts the explanatory portion, and isolates the hint portion, using pattern matching or simple text segmentation. The server translates the correctness information into a numeric comprehension indicator, such as a score between 0 and 1. As output, the server generates a feedback information object containing the explanation text, the hint text, and the comprehension indicator.

### Step 19:

The server updates learning history and learner profile with evaluation results.

The server uses the feedback information object, the answer data, and the prior learner profile as input. The server writes new entries to the learning history database with updated scores and response times, and recalculates per-topic proficiency and difficulty tolerance using statistical functions. The server updates the learner profile data to reflect the new comprehension indicator and recent performance. As output, the server produces an updated learner profile record ready for subsequent adaptive decisions.

### Step 20:

The server determines whether to adjust difficulty and pacing.

The server uses the updated learner profile, recent emotional states, and recent correctness history as input. The server applies a decision algorithm, which may include thresholds on error rates and stress frequency or a classifier that labels the state as overloaded, balanced, or bored. Based on this classification, the server decides whether to lower, maintain, or increase the difficulty level, and whether to modify session length or insert breaks. As output, the server generates an adjustment decision that specifies new target difficulty parameters and pacing parameters.

### Step 21:

The server constructs an update prompt sentence for new content.

The server uses the adjustment decision and the learner profile as input. The server constructs an update prompt sentence that requests new educational content data or training content data suitable for the adjusted difficulty and pacing. For overload, the server may generate a prompt such as: “The learner shows signs of stress and has failed the last two differentiation problems. Please generate simpler practice problems focusing only on recognizing derivatives, and include step-by-step explanations.” For boredom, the server may generate a prompt such as: “The learner has quickly solved the last five problems correctly and appears relaxed. Please generate more challenging problems involving chain rule and product rule combined.” As output, the server produces an update prompt sentence tailored to the current learner state.

### Step 22:

The server obtains new educational or training content from the generative AI model.

The server sends the update prompt sentence as input to the generative information processing apparatus. The generative AI model outputs new content text that matches the requested difficulty and style. The server parses the text, as described previously, into a structured content object. As output, the server generates a new educational content data or training content data object for the adjusted session.

### Step 23:

The server transmits feedback and, if needed, reassurance or relaxation information.

The server uses the feedback information object, the learner's emotional state, and predefined message templates as input. If the learner is anxious or stressed, the server selects an appropriate reassurance message and associated relaxation audio identifier. The server composes a response package that includes the feedback explanation, hint, reassurance message, and playback instructions for relaxation audio. As output, the server sends this response package to the terminal.

### Step 24:

The terminal presents feedback and supportive content to the user.

The terminal receives the response package as input. The terminal displays the feedback explanation and hint on the screen and, if present, shows the reassurance message and starts playback of the relaxation audio. The terminal may also display indicators of comprehension progress. As output, the terminal produces a user-visible feedback view and an active audio stream that assist the user in understanding and reduce stress.

### Step 25:

The server processes industrial operation history for training content generation.

In an industrial training scenario, the server uses operation history data and skill evaluation data for a worker or a machine as input. The server extracts features such as common error steps, time-consuming actions, and safety-critical operations using data analysis methods.

The server then constructs a prompt sentence such as: “Please generate a step-by-step robot operation training program tailored to a new worker with the following skill profile and error history: [skill profile and errors]. Include clear instructions, safety warnings, and checkpoints to verify understanding.” As output, the server produces an industrial training prompt sentence for the generative AI model.

### Step 26:

The server obtains training content data and maps it to visual display steps.

The server sends the industrial training prompt sentence as input to the generative information processing apparatus. The generative AI model returns a detailed training script.

The server parses the script into discrete steps, each with a description and, if necessary, safety warnings and checklist items. The server associates these steps with visual cues or images stored in a content database. As output, the server generates a training content data sequence suitable for presentation on a visual display device.

### Step 27:

The server delivers training steps to a visual display device.

The server uses the training content data sequence as input. The server sends each step, together with associated images and timing or progression rules, to a visual display device such as a head-mounted display or smart glasses. As output, the server provides a sequence of display messages that instruct the visual display device how to present procedures in a real work environment.

### Step 28:

The user performs operations while viewing the training steps.

The user observes the instructions on the visual display device and manipulates physical equipment accordingly as input. The user may confirm completion of each step using a voice command, gesture, or hardware button. As output, the user produces confirmation signals and actual operations in the work environment, which can be sensed by the device or associated sensors.

### Step 29:

The terminal or visual display device reports progress and errors.

The visual display device uses the user confirmation signals and any detected error events as input. The device compiles progress data, including completed steps, repeated attempts, and error flags, and sends it to the server. As output, the device produces a progress report that the server uses to refine training.

### Step 30:

The server updates operation history and, if necessary, regenerates specific training steps.

The server uses the progress report as input. The server writes new entries to the operation history database, updates skill evaluation scores, and detects repeated failure patterns for particular steps. If a step is repeatedly problematic, the server constructs a specialized prompt sentence, such as: “The worker failed step 3 repeatedly. Please generate an alternative explanation for step 3 with simpler language and an additional safety reminder.” The server submits this prompt to the generative AI model and, based on the response, replaces or augments the problematic step. As output, the server produces revised training content data that is sent back to the visual display device, closing the adaptive training loop.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

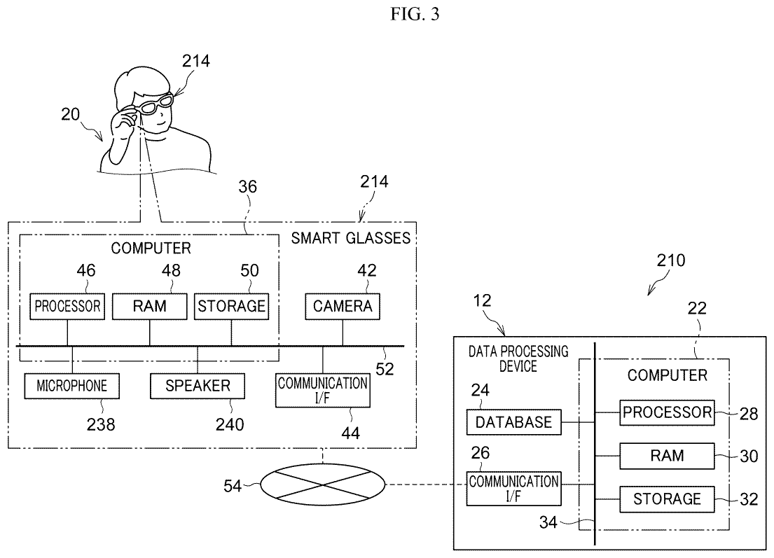

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

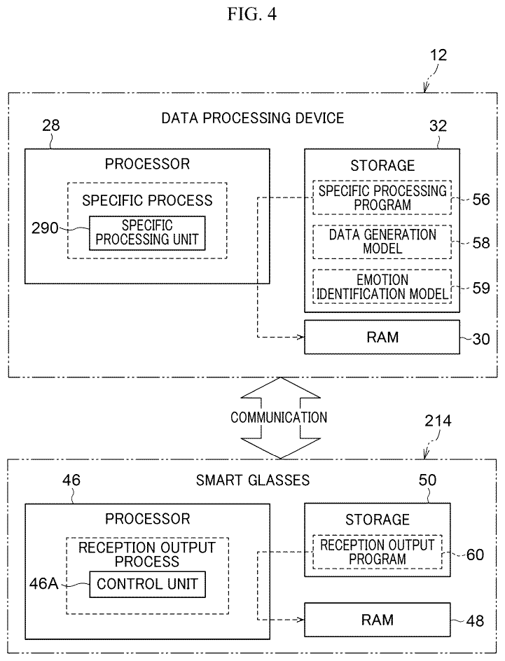

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

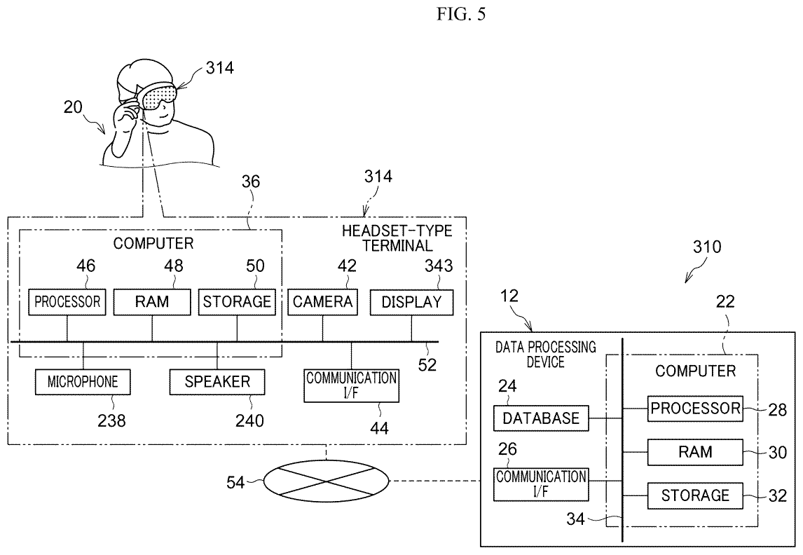

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

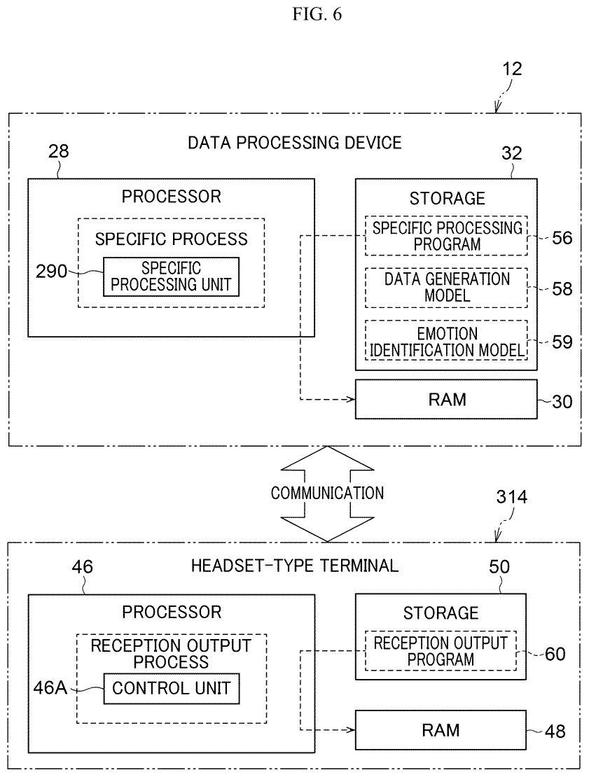

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

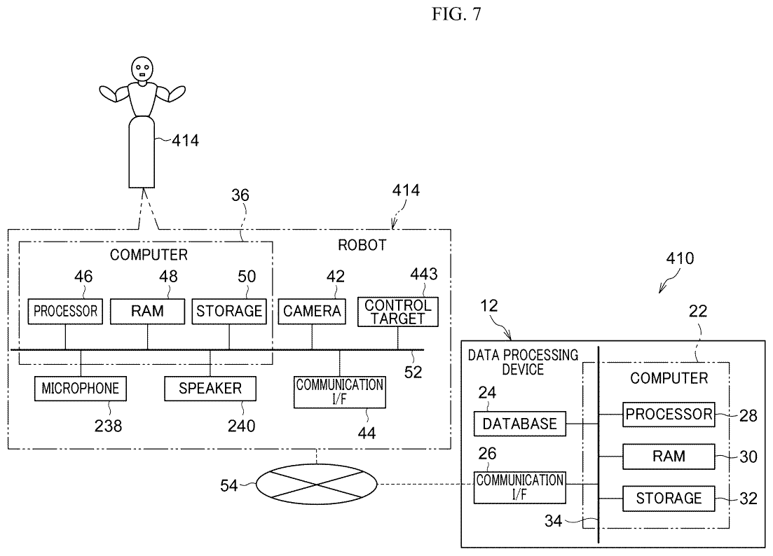

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

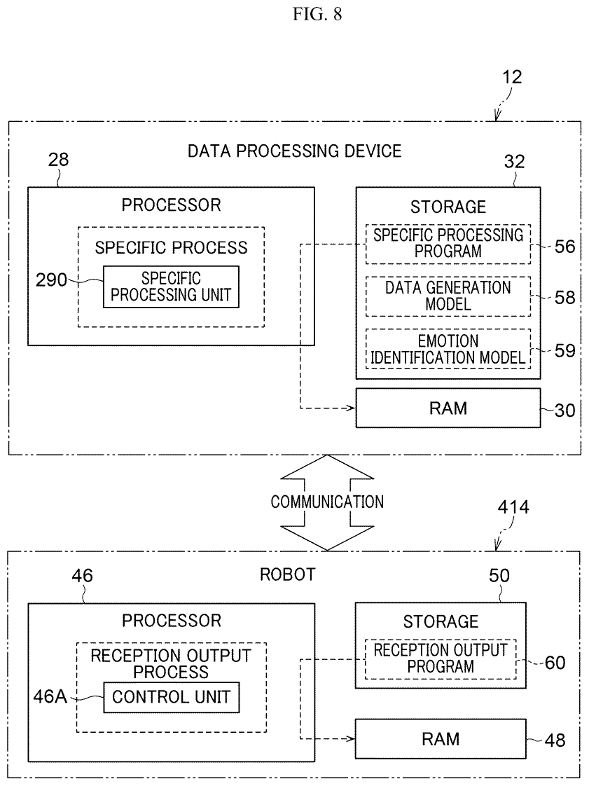

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

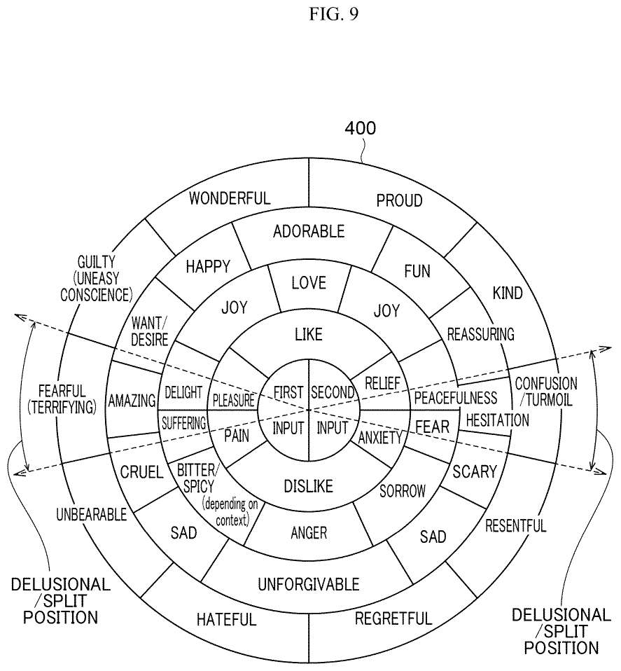

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles.

Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

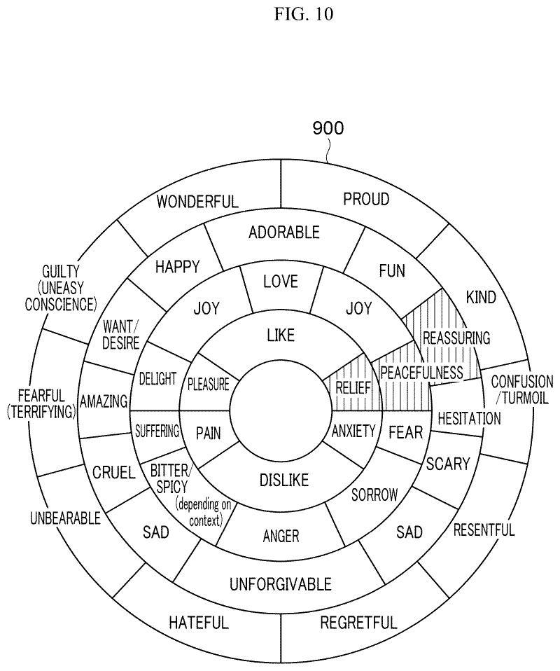

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire learning history information of a learner from an external learning management apparatus via a communication network and store the learning history information in a storage management apparatus,
analyze the learning history information stored in the storage management apparatus by reading the learning history information into an information analysis processing apparatus and performing statistical processing and machine-learning processing so as to identify a learning tendency and generate an analysis result indicating at least a weak domain and a strong domain for each learner,
construct, based on the analysis result and educational target characteristics, a prompt sentence to be input to a generative artificial intelligence model, input the prompt sentence to the generative artificial intelligence model, and cause the generative artificial intelligence model to generate individualized educational content for each learner,
convert the educational content output from the generative artificial intelligence model into a display format, transmit the educational content in the display format to a terminal apparatus, and cause the terminal apparatus to display the educational content,
acquire answer information, operation history information, and learning time information transmitted from the terminal apparatus, append the acquired information to the storage management apparatus, and re-input the acquired information to the information analysis processing apparatus to update the analysis of the learning tendency, and
sequentially change contents of the prompt sentence for the generative artificial intelligence model in accordance with the updated analysis result and cause the generative artificial intelligence model to generate educational content continuously so as to adaptively update educational content.

### Supplementary 2

The system according to supplementary 1,
wherein the processor is configured to
aggregate the learning history information using a numerical computation processing resource to generate feature quantities including at least an average performance for each learning unit, a learning time, and a number of attempts, execute classification processing or clustering processing on the feature quantities using a machine-learning processing resource so as to identify the weak domain and the strong domain based on a result of the classification processing or the clustering processing, and
define the prompt sentence as including condition information that specifies, for the generative artificial intelligence model, at least the weak domain, the strong domain, target difficulty, explanation format, number of practice problems, and explanation style.

### Supplementary 3

The system according to supplementary 1,
wherein the processor is configured to
use model answer information or evaluation criterion information included in the educational content output from the generative artificial intelligence model to automatically determine the answer information acquired from the terminal apparatus, generate correctness information and score information, transmit the correctness information and the score information to the terminal apparatus to provide immediate feedback to the learner, store the correctness information and the score information as part of the learning history information in the storage management apparatus, and reflect the correctness information and the score information in subsequent generation of the prompt sentence and subsequent generation of the educational content.

### Application Example 1

### Supplementary 1

A system comprising a processor,
wherein the processor is configured to
acquire, based on identification information of a learner included in input information,
learning history information from a storage device, and execute aggregation processing and statistical processing on performance information and behavioral information included in the learning history information for each learning item to identify a weak area of the learner,
dynamically construct a prompt sentence for instructing a generative AI model to generate educational information, based on the weak area and attribute information regarding the learner, and input generation instruction information including the prompt sentence into the generative AI model,
obtain personalized educational information output from the generative AI model in response to the prompt sentence, convert the educational information into a display data format, and distribute the converted educational information to an information terminal,
update the learning history information based on response information and operation information of the learner with respect to the educational information acquired from the information terminal, and repeatedly execute a process of identifying the weak area and dynamically constructing the prompt sentence on the updated learning history information so as to incrementally optimize the educational information,
acquire an emotional state of the learner over time, and adjust a difficulty level and an amount of presentation of the educational information generated by the generative AI model by changing a difficulty condition and a learning pace condition in the prompt sentence according to the emotional state, and
evaluate a learning progress and a level of understanding of the learner based on an analysis result using the generative AI model and the learning history information, generate immediate feedback information according to an evaluation result, and transmit the immediate feedback information to the information terminal.

### Supplementary 2

The system according to supplementary 1,
wherein the processor is configured to execute a character string generation process that embeds parameters into a template of the prompt sentence for instructing the generative AI model to generate optimized educational information, using the learning history information and information regarding the weak area, and to input, into the generative AI model as the generation instruction information, the prompt sentence obtained by the character string generation process.

### Supplementary 3

The system according to supplementary 1,
wherein the processor is configured to input, into the generative AI model, answer information and answer time information of the learner with respect to questions included in the educational information, use a prompt sentence that causes the generative AI model to analyze the answer information to extract an error tendency and the level of understanding, and generate, based on an extraction result, a new prompt sentence including parameters for specifying feedback content and a question range and a difficulty level of educational information to be generated next.

### Example 2

### Supplementary 1

A system comprising a processor,
wherein the processor is configured to
input a prompt sentence to a generative AI model in order to instruct generation of educational content, and cause the generative AI model to generate educational content according to attribute information and behavioral information of a learner,
and acquire operation information and answer information of the learner transmitted from a terminal device, associate the acquired information with time-series information as learning activity information, compute learning indicators including a number of questions, a number of correct answers, a correctness ratio, a learning time, and a response time for each learner by using the learning activity information, and generate understanding evaluation information,
and dynamically construct the prompt sentence to be input to the generative AI model on the basis of the understanding evaluation information and history information of the learner,
input the prompt sentence to the generative AI model, and cause the generative AI model to generate personalized feedback information and next learning step instruction information for each learner,
and estimate an emotional state or load state of the learner by using the learning activity information and the understanding evaluation information, generate control information for adjusting a difficulty level and a presentation speed of the educational content according to an estimation result, and reflect the control information in the prompt sentence to the generative AI model or in output control information to the terminal device,
and transmit the feedback information and the instruction information acquired from the generative AI model to the terminal device, and cause the terminal device to immediately display and present the feedback information and the instruction information to the learner,
and store the educational content, the learning activity information, the understanding evaluation information, and the feedback information in association with each other, and
manage the stored information as learning history information that is reusable for subsequent prompt sentence generation and educational content generation.

### Supplementary 2

The system according to supplementary 1,
wherein the processor is configured to
automatically generate the prompt sentence on the basis of evaluation information including a subject area, a learning unit, the correctness ratio, the learning time, a weak area, and past feedback content of the learner, by using a templated sentence structure, and embed variable parts of the evaluation information into the templated sentence structure.

### Supplementary 3

The system according to supplementary 1,
wherein the processor is configured to
instruct, by using the prompt sentence, the generative AI model to generate feedback information suitable for a learner having an understanding level represented by a predetermined ratio, or to recommend educational content to be presented next, present a natural-language response acquired from the generative AI model to the learner as the feedback information, and automatically change an order and a type of the educational content to be presented to the learner on the basis of content of the natural-language response.

### Application Example 2

### Supplementary 1

A system comprising a processor,
wherein the processor is configured to
acquire, from a storage device, learning history information, learning tendency information, and learning objective information regarding a learning subject, and generate learner profile data representing an ability characteristic and a comprehension level of the learning subject based on the acquired information,
perform emotion estimation processing by using image information, audio information, or biometric information acquired from a terminal device, thereby recognizing, in real time and in association with time information, an emotional state of the learning subject, and store the emotional state in association with the learner profile data,
generate a prompt sentence for instructing a generative information processing apparatus to generate or select educational content, based on the learner profile data and the emotional state, provide the prompt sentence as input data to the generative information processing apparatus, and cause the generative information processing apparatus to generate educational content data adapted to the learning subject,
generate a prompt sentence for inputting to the generative information processing apparatus an evaluation data set including the generated educational content data, answer data from the learning subject with respect to the educational content data, and answer time information, cause the generative information processing apparatus to execute analysis processing of the evaluation data set based on the prompt sentence, and obtain, as an analysis result, a comprehension indicator and feedback information,
dynamically adjust a difficulty level, a presentation order, and a time allocation of a learning session for the educational content data based on the comprehension indicator, the emotional state, and the learner profile data, and successively input update prompt sentences to the generative information processing apparatus in accordance with a result of the adjustment, thereby causing the generative information processing apparatus to generate, in stages, new educational content data or training content data,
transmit the feedback information and reassurance message information or relaxation audio information generated in accordance with the emotional state to the terminal device, and cause the terminal device to present the feedback information and the reassurance message information or the relaxation audio information immediately to the learning subject, and obtain operation history data and skill evaluation data regarding an industrial worker or a machine, generate a prompt sentence for the generative information processing apparatus based on the operation history data and the skill evaluation data, thereby causing the generative information processing apparatus to generate training content data including procedure information for work training, and transmit the training content data to a visual display device so that the training content data is sequentially presented in a real work environment.

### Supplementary 2

The system according to supplementary 1,
wherein the processor is configured to generate statistical information by aggregating the learning history information, the learning tendency information, and the comprehension indicator, generate a prompt sentence including summary data containing the statistical information for input to the generative information processing apparatus, cause the generative information processing apparatus to generate individual learning plan data based on the prompt sentence, and control a type and a presentation timing of the educational content data in accordance with the individual learning plan data.

### Supplementary 3

The system according to supplementary 1,
wherein the processor is configured to periodically aggregate a plurality of kinds of state data including the emotional state and the operation history data, generate a prompt sentence using an aggregation result as input to the generative information processing apparatus, obtain recommendation information indicating an adjustment policy for an educational strategy or a training strategy from the generative information processing apparatus based on the prompt sentence, and update at least one of a generation rule of the prompt sentence, a difficulty adjustment condition, and a session time setting based on the recommendation information.

What is claimed is:

1. A system comprising:
circuitry configured to:
receive, via a communication interface coupled to a packet-switched network, historical performance data from an external management apparatus, and store the historical performance data in a storage device;
aggregate the historical performance data using numerical computation processing to generate feature quantities comprising at least an average performance metric for each subject domain, a session duration, and an attempt count, and execute machine-learning-based analysis on the feature quantities to identify a low-performance domain and a high-performance domain;
construct a prompt sentence based on the analysis result and target characteristics, the prompt sentence comprising condition information specifying at least the low-performance domain, the high-performance domain, a target difficulty level, an explanation format, and a number of practice items, and input the prompt sentence to a generative AI model to generate content items adapted to the identified domain characteristics;
receive real-time sensor data from a terminal device, apply an emotion recognition model to the sensor data to generate an emotional state representation, and adjust at least one of a difficulty parameter and a session pacing parameter of the content items based on the emotional state representation; and
evaluate a progress metric and a comprehension level of a user based on response data received from the terminal device, and generate feedback data by inputting an evaluation result and a prompt sentence to the generative AI model.

2. The system according to claim 1, wherein the circuitry is configured to
transmit the feedback data to the terminal device via the communication interface, the feedback data comprising at least an explanation of incorrect response items, a recommended review domain, and a suggested adjustment to the session pacing parameter.

3. The system according to claim 2, wherein the circuitry is configured to
apply a performance trend analysis model to accumulated response data stored in the storage device to identify improvement rates and plateaus in each subject domain, and incorporate identified plateaus as high-priority parameters in subsequent prompt sentence construction.

4. The system according to claim 3, wherein the circuitry is configured to
generate recommendation information indicating an adjustment policy for the prompt sentence generation rules, the difficulty adjustment condition, and the session pacing parameter based on accumulated performance data, and update the generation rules based on the recommendation information.

5. The system according to claim 4, wherein the circuitry is configured to
apply a collaborative filtering model to performance data of a plurality of users stored in the storage device to identify learning pattern similarities, and use the identified learning pattern similarities to supplement the prompt sentence condition information.

6. The system according to claim 1, wherein the circuitry is configured to
receive audio data and image data from the terminal device, apply a voice activity detection model to segment the audio data into utterance units, apply a facial expression recognition model to the image data to generate an expression classification, and combine the expression classification with prosodic features extracted from the audio data in the emotion recognition model.

7. The system according to claim 6, wherein the circuitry is configured to
update the emotional state representation at predetermined intervals during a session based on continuously received audio data and image data, and dynamically adjust the difficulty parameter and the session pacing parameter based on the updated emotional state representation.

8. The system according to claim 1, wherein the circuitry is configured to
apply a weighted aggregation function to the feature quantities to compute a composite performance score for each subject domain, and rank subject domains by composite performance score to determine prioritization order for the prompt sentence condition information.

9. The system according to claim 8, wherein the circuitry is configured to
apply a clustering algorithm to the feature quantities of a plurality of users to identify performance profile clusters, and assign the user to a performance profile cluster for use as a conditioning parameter in the prompt sentence.

10. The system according to claim 1, wherein the circuitry is configured to
generate the content items in a structured format comprising a presentation section, a practice section, and an assessment section, and adapt the length and complexity of each section based on the difficulty parameter derived from the emotional state representation.

11. The system according to claim 10, wherein the circuitry is configured to
apply a readability analysis model to the generated content items to verify that the content complexity matches the target difficulty level, and re-generate sections that do not satisfy the target difficulty level using an updated prompt sentence.

12. The system according to claim 1, wherein the circuitry is configured to
evaluate the comprehension level of the user by applying a natural language understanding model to free-text response data received from the terminal device, and incorporate a comprehension score derived from the free-text response data in the feedback data.

13. The system according to claim 12, wherein the circuitry is configured to
generate feedback data comprising a detailed explanation of misunderstood concepts identified in the free-text response data, and transmit the feedback data to the terminal device for presentation to the user.

14. The system according to claim 1, wherein the circuitry is configured to
accumulate emotional state representations and corresponding difficulty adjustment events in the storage device, and apply a pattern analysis model to the accumulated data to identify correlations between emotional state patterns and learning effectiveness metrics.

15. The system according to claim 14, wherein the circuitry is configured to
update difficulty adjustment rules based on the identified correlations to improve alignment between the emotional state representation and the difficulty parameter adjustment.

16. The system according to claim 1, wherein the circuitry is configured to
retrieve external reference content from an external data source via the communication interface based on the low-performance domain, and incorporate the retrieved external reference content as supplementary conditioning information in the prompt sentence.

17. The system according to claim 16, wherein the circuitry is configured to
apply a relevance scoring model to the retrieved external reference content to filter content items below a relevance threshold, and include only high-relevance content items in the prompt sentence.

18. A system comprising:
circuitry configured to:
receive, via a communication interface coupled to a packet-switched network, historical performance data from an external management apparatus, aggregate the historical performance data to generate feature quantities comprising average performance metrics, session durations, and attempt counts for each subject domain, and execute machine-learning-based analysis to identify a low-performance domain and a high-performance domain;
construct a prompt sentence incorporating the low-performance domain, the high-performance domain, a target difficulty level, and an explanation format, and input the prompt sentence to a generative AI model to generate content items comprising a presentation section, a practice section, and an assessment section;
receive real-time audio data and image data from a terminal device, apply a facial expression recognition model to the image data and a voice analysis model to the audio data to generate an emotional state representation, and dynamically adjust difficulty parameters and session pacing parameters based on the emotional state representation; and
evaluate a progress metric and a comprehension level based on response data received from the terminal device, generate feedback data incorporating an evaluation result and identified misunderstood concepts, and transmit the feedback data to the terminal device via the communication interface.

19. The system according to claim 18, wherein the circuitry is configured to
accumulate emotional state representations and corresponding difficulty adjustment events in the storage device, apply a pattern analysis model to identify correlations between emotional state patterns and learning effectiveness metrics, and update difficulty adjustment rules based on the identified correlations.

20. A method comprising:
receiving, via a communication interface coupled to a packet-switched network, historical performance data from an external management apparatus, and storing the historical performance data in a storage device;
aggregating the historical performance data using numerical computation processing to generate feature quantities comprising at least an average performance metric for each subject domain, a session duration, and an attempt count, and executing machine-learning-based analysis on the feature quantities to identify a low-performance domain and a high-performance domain;
constructing a prompt sentence based on the analysis result and target characteristics, the prompt sentence comprising condition information specifying at least the low-performance domain, the high-performance domain, a target difficulty level, an explanation format, and a number of practice items, and inputting the prompt sentence to a generative AI model to generate content items adapted to the identified domain characteristics;
receiving real-time sensor data from a terminal device, applying an emotion recognition model to the sensor data to generate an emotional state representation, and adjusting at least one of a difficulty parameter and a session pacing parameter of the content items based on the emotional state representation; and
evaluating a progress metric and a comprehension level of a user based on response data received from the terminal device, and generating feedback data by inputting an evaluation result and a prompt sentence to the generative AI model.
